(19) United States
(12) Patent Application Publication
(10) Pub. No.: US 2026/0105337 A1
(43) Pub. Date: Apr. 16, 2026

(54) INTELLIGENT UNITARY SYNTHESIS FOR QUANTUM COMPUTING

(71) Applicant: International Business Machines Corporation, Armonk, NY (US)

(72) Inventors: David Kremer Garcia, White Plains, NY (US); Victor Villar Pascual, Scarsdale, NY (US); Sanjay Kumar Lalta Prasad Vishwakarma, Sunnyvale, CA (US); Juan Cruz Benito, Salamanca (ES); Francisco Jose Martin Fernandez, Ridgefield, CT (US); Ivan Duran Martinez, Elmsford, NY (US); Alexandra Rivero García, La Orotava (ES); Ismael Faro Sertage, Chappaqua, NY (US)

(21) Appl. No.: 18/915,476

(22) Filed: Oct. 15, 2024

(51) Int. Cl. G06N 10/20; G06N 3/045; G06N 3/084; G06N 10/80

(52) U.S. Cl. CPC G06N 10/20; G06N 3/045; G06N 3/084; G06N 10/80

(57) ABSTRACT

Systems/techniques that facilitate intelligent unitary synthesis for quantum computing are provided. In various embodiments, a system can access a unitary matrix of a quantum payload circuit, where the unitary matrix can be outside of design constraints of an architecture of a quantum computer. In various aspects, the system can synthesize the unitary matrix into a transpiled unitary matrix that is within the design constraints of the architecture of the quantum computer, based on deep learning initialization of adjustable parameters of quantum circuit templates.

### BACKGROUND

The subject disclosure relates to quantum circuit transpilation.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate intelligent unitary synthesis for quantum computing are described.

According to one or more embodiments, a system is provided. In various aspects, the system can comprise a processor that can execute computer-executable instructions stored in a non-transitory computer-readable memory. In various instances, such execution can cause the processor to facilitate various operations. In various cases, such operations can comprise accessing a unitary matrix of a quantum payload circuit, where the unitary matrix can be outside of design constraints of an architecture of a quantum computer. In various cases, such operations can comprise synthesizing the unitary matrix into a transpiled unitary matrix that is within the design constraints of the architecture of the quantum computer, based on deep learning initialization of adjustable parameters of quantum circuit templates.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates intelligent unitary synthesis for quantum computing in accordance with one or more embodiments described herein.

FIG. 2 illustrates example, non-limiting circuit diagrams of quantum circuit templates in accordance with one or more embodiments described herein.

FIG. 3 illustrates a block diagram of an example, non-limiting system including a template selection deep learning neural network, a plurality of parameter initialization deep learning neural networks, and a transpiled unitary matrix that facilitates intelligent unitary synthesis for quantum computing in accordance with one or more embodiments described herein.

FIGS. 4-8 illustrate example, non-limiting block diagrams showing how a template selection deep learning neural network and a plurality of parameter initialization deep learning neural networks can be leveraged to generate a transpiled unitary matrix in accordance with one or more embodiments described herein.

FIG. 9 illustrates a flow diagram of an example, non-limiting computer-implemented method that facilitates intelligent unitary synthesis for quantum computing in accordance with one or more embodiments described herein.

FIG. 10 illustrates a block diagram of an example, non-limiting system including a transpiled quantum payload circuit that facilitates intelligent unitary synthesis for quantum computing in accordance with one or more embodiments described herein.

FIG. 11 illustrates an example, non-limiting block diagram showing how a template selection deep learning neural network can be trained in accordance with one or more embodiments described herein.

FIG. 12 illustrates an example, non-limiting block diagram showing how a parameter initialization deep learning neural network can be trained in accordance with one or more embodiments described herein.

FIGS. 13-16 illustrate example, non-limiting experimental results in accordance with one or more embodiments described herein.

FIG. 17 illustrates a flow diagram of an example, non-limiting computer-implemented method that facilitates intelligent unitary synthesis for quantum computing in accordance with one or more embodiments described herein.

FIG. 18 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum computer can be any suitable device that utilizes a qubit lattice (e.g., a plurality of superconducting qubits fabricated on one or more quantum substrates and exhibiting any suitable connection topology) for information processing. A quantum circuit can be a sequence of any suitable number of parallel or series quantum gates that can be executed on a quantum computer. A quantum gate can be a basic component of a quantum circuit that can change, alter, or otherwise affect the state of a qubit. As some non-limiting examples, a quantum gate can be any suitable single-qubit gate (e.g., Pauli-X gates (X), Pauli-Y gates (Y), Pauli-Z gates (Z), Phase gates(S), Rotation gates (RX, RY, RZ), Hadamard gates (H)) or any suitable entangling or two-qubit gate (e.g., Controlled-Not gates (CNOT), Controlled-Phase gates (CS), Controlled-Z gates (CZ)). Quantum gates can be combined in series via matrix multiplication or in parallel via tensor products.

In quantum computing, transpiling is the process of adapting, rewriting, or rearranging a given quantum circuit so that it can be implemented on, performed on, executed on, or otherwise supported by the specific architecture of a given quantum computer. Indeed, different quantum computers involve different qubit hardware (e.g., superconducting qubit hardware, quantum dot qubit hardware, spin qubit hardware) or different qubit coupling topologies (e.g., lattice coupling topologies, linear nearest neighbor coupling topologies, caterpillar coupling topologies). Thus, certain types of one-qubit or two-qubit quantum gates might be performable on the architectures of some quantum computers but not on the architectures of other quantum computers. Transpiling can be considered as the process of reformatting quantum circuits so as to be performable on desired quantum hardware. In other words, transpiling can be considered as translating a given quantum circuit from a language that is native to or otherwise understood by one quantum computer to another language that is native to or otherwise understood by another quantum computer.

Unitary synthesis can be considered as a foundational constituent task within transpiling. Specifically, a quantum circuit (or a portion thereof) whose inverse is equal to its conjugate transpose can be referred to as a unitary matrix. When given a unitary matrix, unitary synthesis involves finding a sequence of quantum gates that are native to, implementable on, or otherwise supported by the architecture of a particular quantum computer, where that sequence of gates is functionally equivalent to (e.g., performs the same overall quantum state transformation as) the given unitary matrix. That is, unitary synthesis can be considered as the process of translating the given unitary matrix into a language that is native to or otherwise understood by a particular quantum computer. In practice, many different types of quantum payload circuits are constructed from different combinations or permutations of different types of unitary matrices.

Some existing techniques facilitate unitary synthesis in exact fashion, such as KAK-based decomposition or Quantum Shannon Decomposition. These existing techniques provide excellent performance for unitary matrices that operate on two qubits. However, these existing techniques do not scale to unitary matrices that operate on three or more qubits.

Other existing techniques facilitate unitary synthesis in approximate fashion. These other existing techniques approximate or estimate a given unitary matrix (as opposed to exactly matching the given unitary matrix) via the use of quantum circuit templates. A quantum circuit template can be a circuit that has a defined structure or arrangement of quantum gates that are known or deemed to be implementable on a desired quantum computer, where those quantum gates include or otherwise involve one or more adjustable or variable parameters. As a non-limiting example, a quantum circuit template can include one or more rotation gates (e.g., one or more RZ gates) that are in a fixed arrangement or layout with respect to each other, and the respective amounts of rotation implemented by those one or more rotation gates can be considered as one or more adjustable or variable parameters of that quantum circuit template (e.g., the amounts of rotation can be controllable, changeable, or otherwise selectable). Accordingly, when given a quantum circuit template and a unitary matrix, such other existing techniques involve iteratively adjusting (e.g., via stochastic gradient descent) the adjustable or variable parameters of the given quantum circuit template so as to maximize a fidelity of that given quantum circuit template with respect to the given unitary matrix (e.g., so as to minimize a functional difference or error between the given quantum circuit template and the given unitary matrix). Unlike existing techniques that facilitate exact unitary synthesis, existing techniques that facilitate approximate unitary synthesis can be scaled to unitary matrices that operate on three or more qubits.

However, the inventors of various embodiments described herein nevertheless realized that existing techniques which facilitate approximate unitary synthesis suffer from various disadvantages.

First, there are often a multitude of quantum circuit templates that can be implemented on any given quantum computer, and, unfortunately, not every unitary matrix can be approximated by each of that multitude of quantum circuit templates. For example, a given unitary matrix might be able to be approximated (e.g., up to a threshold level of fidelity) by some of those quantum circuit templates but not by others of those quantum circuit templates. It can be unknown in advance which quantum circuit templates are suitable for the given unitary matrix and which quantum circuit templates are not. Accordingly, selecting which quantum circuit template to iteratively adjust or change so as to synthesize or transpile the given unitary matrix can be considered as a non-trivial task. Existing techniques that facilitate approximate unitary synthesis deal with this uncertainty in an exhaustive fashion. Specifically, such existing techniques try (e.g., iteratively update the adjustable or variable parameters of) every quantum circuit template in a random sequential order (e.g., one randomly-chosen template at a time) until a template is found that achieves a threshold fidelity with respect to the given unitary matrix. As the present inventors recognized, such random guessing as to which quantum circuit template to try can be quite time-consuming (e.g., very many templates that end up being unsuitable can be tried before a template that ends up being suitable).

Second, even if a template that ultimately ends up being suitable is chosen (again, it is not known in advance whether a given template is capable of achieving the threshold fidelity with respect to the given unitary matrix), the present inventors recognized that iteratively updating the adjustable or variable parameters of that template according to existing techniques can be excessively time-consuming and even inaccurate. Indeed, for a given quantum circuit template and a given unitary matrix, existing techniques iteratively update or change the adjustable or variable parameters of that given quantum circuit template by performing stochastic gradient descent, where an objective or goal of such stochastic gradient descent is to minimize or reduce a difference or error between the given quantum circuit template and the given unitary matrix. In other words, the objective or goal can be to maximize a fidelity that the given quantum circuit template exhibits with respect to the given unitary matrix. During such stochastic gradient descent, the adjustable or variable parameters of the given quantum circuit template are randomly initialized (e.g., are assigned random starting values) and are, during each iteration, incrementally updated in a direction that reduces the error between the given quantum circuit template and the given unitary matrix (e.g., in a direction that increases the fidelity that the given quantum circuit template exhibits with respect to the given unitary matrix). When existing techniques are implemented, many thousands of stochastic gradient descent iterations can be required in order to cause the given quantum circuit template to achieve the threshold fidelity. Furthermore, when existing techniques are implemented, stochastic gradient descent can sometimes become trapped at local minima. In other words, even if the given quantum circuit template is capable of achieving the threshold fidelity with respect to the given unitary matrix, stochastic gradient descent as implemented by existing techniques can sometimes be unable to find what specific values of the adjustable or variable parameters of the given quantum circuit template achieve that threshold fidelity.

The present inventors devised various techniques described herein, which can help to address or ameliorate various of the above-described technical problems that plague existing techniques for facilitating approximate unitary synthesis. In particular, the present inventors realized that artificial intelligence (e.g., deep learning) can be leveraged so as to help solve such technical problems.

Specifically, when given a unitary matrix and a collection of quantum circuit templates, various embodiments described herein can involve leveraging deep learning so as to intelligently determine in which sequential order those quantum circuit templates should be attempted to synthesize or transpile the given unitary matrix. In other words, the present inventors realized that deep learning can be able to map or otherwise extract heretofore unknown or unseeable patterns or correlations between: the characteristics or properties of the given unitary matrix; and the suitability of different templates for approximating the given unitary matrix. In still other words, the present inventors realized that deep learning can be able to predict or infer which of the collection of quantum circuit templates are most likely to be suitable for the given unitary matrix (e.g., are most likely to achieve the threshold fidelity with respect to the given unitary matrix) and which of the collection of quantum circuit templates are least likely to be suitable for the given unitary matrix (e.g., are least likely to achieve the threshold fidelity with respect to the given unitary matrix). Accordingly, whichever templates are predicted or inferred to be most likely to be suitable can be attempted or tried before those that are predicted or inferred to be least likely to be suitable. Thus, various embodiments described herein can consume significantly less time than existing techniques that instead attempt or try quantum circuit templates in a random order.

Additionally, when given a unitary matrix and a quantum circuit template that has been selected to attempt or try to synthesize or transpile the given unitary matrix, various embodiments described herein can involve leveraging deep learning so as to intelligently select a non-random parameter initialization for stochastic gradient descent. In other words, the present inventors realized that deep learning can be able to map or otherwise extract heretofore unknown or unseeable patterns or correlations between: the characteristics or properties of the given unitary matrix: and what specific values should be initially assigned to the adjustable or variable parameters of the given quantum circuit template so as to maximize fidelity exhibited by that given quantum circuit template with respect to the given unitary matrix. In still other words, the present inventors realized that deep learning can be able to predict or infer which starting values should be assigned to the adjustable or variable parameters of the given quantum circuit template, so as to maximize or otherwise increase a likelihood that performing stochastic gradient descent on the given quantum circuit will cause the given quantum circuit to achieve the threshold fidelity with respect to the given unitary matrix. Such intelligent parameter initialization can significantly reduce the total number of stochastic gradient descent iterations that are needed to achieve the threshold fidelity, as compared to existing techniques that instead start from a random parameter initialization. Furthermore, such intelligent parameter initialization can eliminate or otherwise reduce instances of stochastic gradient descent becoming trapped at local minima, unlike existing techniques that instead start from a random parameter initialization.

Accordingly, various embodiments described herein can be considered as concrete technical improvements in quantum circuit transpilation.

Various embodiments described herein can be considered as a computerized tool (e.g., any suitable combination of computer-executable hardware or computer-executable software) that can facilitate intelligent unitary synthesis for quantum computing. In various aspects, such a computerized tool can comprise an access component, a synthesis component, or an execution component.

In various embodiments, there can be a quantum computer. In various aspects, the quantum computer can comprise any suitable number of qubits. In various instances, such qubits can exhibit any suitable structures, constructions, or architectures (e.g., can be superconducting qubits, spin qubits, or quantum dots). In various cases, the qubits of the quantum computer can be arranged or connected according to any suitable coupling topology.

In various embodiments, there can be a plurality of quantum circuit templates. In various aspects, each quantum circuit template can be composed or otherwise made up of any suitable quantum gates (e.g., single-qubit gates, or two-qubit entangling gates) that can operate on the qubits of the quantum computer (e.g., that can be facilitated by the coupling topology of the quantum computer). In various instances, the quantum gates that make up any given quantum circuit template can be organized in a fixed arrangement or sequence with respect to each other (e.g., the positions or locations of the quantum gates in the given quantum circuit template can be considered as not being adjustable or changeable; different quantum circuit templates can have differently positioned, arranged, or located quantum gates). Nevertheless, in various cases, the quantum gates that make up the given quantum circuit template can have one or more adjustable parameters (e.g., the angle of rotation implemented by a rotation gate can be considered as adjustable, changeable, or variable).

In various embodiments, there can be a quantum payload circuit. In various aspects, the quantum payload circuit can be any suitable circuit of any suitable depth that is configured to operate on the qubits of the quantum computer. In various instances, the quantum payload circuit can contain a unitary matrix. In other words, the unitary matrix can be a constituent part or portion of the quantum payload circuit. In various cases, the unitary matrix can be currently formatted in a fashion that is not implementable on the quantum computer (e.g., the unitary matrix might include an entangling gate between two qubits that are not coupled together in the coupling topology of the quantum computer).

In various aspects, it can be desired to synthesize or transpile the unitary matrix so that it is implementable on the quantum computer. As described herein, the computerized tool can facilitate such synthesis or transpilation.

In various embodiments, the access component of the computerized tool can electronically access, via any suitable wired or wireless electronic connections, the quantum computer. In various instances, the access component can further access or otherwise receive, retrieve, or import from any suitable source the unitary matrix. For example, the access component can obtain the unitary matrix from any suitable centralized or decentralized data structure (e.g., graph data structure, relational data structure, hybrid data structure), whether remote from or local to the access component. In any case, the access component can access the quantum computer or the unitary matrix, such that other components of the computerized tool can electronically interact with (e.g., power-up, power-down, initialize, control) the quantum computer or can electronically interact with (e.g., read, write, edit, copy, manipulate, execute) the unitary matrix.

In various embodiments, the synthesis component can electronically store, maintain, control, or otherwise access a template selection deep learning neural network or a plurality of parameter initialization deep learning neural networks.

In various aspects, the template selection deep learning neural network can exhibit any suitable deep learning internal architecture. For example, the template selection deep learning neural network can include any suitable numbers of any suitable types of layers (e.g., input layer, one or more hidden layers, output layer, any of which can be convolutional layers, dense layers, long short-term memory (LSTM) layers, non-linearity layers, pooling layers, batch normalization layers, or padding layers). As another example, the template selection deep learning neural network can include any suitable numbers of neurons in various layers (e.g., different layers can have the same or different numbers of neurons as each other). As yet another example, the template selection deep learning neural network can include any suitable activation functions (e.g., softmax, sigmoid, hyperbolic tangent, rectified linear unit) in various neurons (e.g., different neurons can have the same or different activation functions as each other). As still another example, the template selection deep learning neural network can include any suitable interneuron connections or interlayer connections (e.g., forward connections, skip connections, recurrent connections).

Regardless of its specific internal architecture, the template selection deep learning neural network can be configured as a template classifier that is associated with the quantum computer. That is, the template selection deep learning neural network can be configured to receive as input any unitary operator and to determine as output to which of the plurality of quantum circuit templates that unitary operator most relates. Accordingly, the synthesis component can electronically execute the template deep learning neural network on the unitary matrix of the quantum payload circuit, and such execution can yield a template classification label. More specifically, the synthesis component can feed the unitary matrix to the input layer of the template selection deep learning neural network, the unitary matrix can complete a forward pass through the one or more hidden layers of the template selection deep learning neural network, and the output layer of the template selection deep learning neural network can calculate the template classification label based on activations provided by the one or more hidden layers of the template selection deep learning neural network.

In various aspects, the template classification label can be considered as ranking the plurality of quantum circuit templates in order of synthesis suitability or transpilation suitability with respect to the unitary matrix. In particular, the plurality of quantum circuit templates can be considered as being all available candidates that could be used or attempted to synthesize or transpile the unitary matrix, and the template classification label can assign a respective probability score to each of the plurality of quantum circuit templates, where higher probability scores indicate more synthesis suitability, and where lower probability scores indicate less synthesis suitability. In other words, the unitary matrix can be considered as containing unique or distinctive characteristics, and the template selection deep learning neural network can be considered as recognizing those unique or distinctive characteristics so as to infer how likely it is that each of the plurality of quantum circuit templates can successfully be used to synthesize or transpile the unitary matrix. Note that, in some cases, the template classification label can include a “no template is suitable” class, so as to address situations in which none of the plurality of quantum circuit templates could successfully be used to synthesize or transpile the unitary matrix.

In various aspects, the plurality of parameter initialization deep learning neural networks can respectively correspond (e.g., in one-to-one fashion) to the plurality of quantum circuit templates (e.g., one parameter initialization deep learning neural network per quantum circuit template). In various instances, each of the plurality of parameter initialization deep learning neural networks can exhibit any suitable deep learning internal architecture. For example, any parameter initialization deep learning neural network can include any suitable numbers of any suitable types of layers (e.g., input layer, one or more hidden layers, output layer, any of which can be convolutional layers, dense layers, LSTM layers, non-linearity layers, pooling layers, batch normalization layers, or padding layers). As another example, any parameter initialization deep learning neural network can include any suitable numbers of neurons in various layers (e.g., different layers can have the same or different numbers of neurons as each other). As yet another example, any parameter initialization deep learning neural network can include any suitable activation functions (e.g., softmax, sigmoid, hyperbolic tangent, rectified linear unit) in various neurons (e.g., different neurons can have the same or different activation functions as each other). As still another example, any parameter initialization deep learning neural network can include any suitable interneuron connections or interlayer connections (e.g., forward connections, skip connections, recurrent connections).

Regardless of its specific internal architecture, each of the plurality of parameter initialization deep learning neural networks can be configured as an adjustable parameter regressor that is associated with a respective one of the plurality of quantum circuit templates. That is, for a given parameter initialization deep learning neural network that corresponds to a given quantum circuit template, the given parameter initialization deep learning neural network can be configured to receive as input any unitary operator and to produce as output initialized values (e.g., which may be real or complex) that can be assigned to the adjustable parameters (e.g., to variable rotation angles) of the given quantum circuit template. Accordingly, the synthesis component can electronically execute the given parameter initialization deep learning neural network on the unitary matrix of the quantum payload circuit, and such execution can yield a parameter initialization. More specifically, the synthesis component can feed the unitary matrix to the input layer of the given parameter initialization deep learning neural network, the unitary matrix can complete a forward pass through the one or more hidden layers of the given parameter initialization deep learning neural network, and the output layer of the given parameter initialization deep learning neural network can calculate the parameter initialization based on activations provided by the one or more hidden layers of the given parameter initialization deep learning neural network.

In various aspects, the parameter initialization can be considered as any suitable electronica data that indicates specific values that can be assigned to the adjustable parameters of the given quantum circuit template and that the given parameter initialization deep learning neural network believes will maximize a fidelity exhibited by the given quantum circuit template with respect to the unitary matrix. As a non-limiting example, if the given quantum circuit template has a total of x adjustable parameters, then the parameter initialization can indicate x specific values that can be respectively assigned to those x adjustable parameters of the given quantum circuit template, where those x specific values are inferred or predicted to maximize the fidelity of the given quantum circuit template with respect to the unitary matrix (e.g., where those x specific values are inferred or predicted to make the given quantum circuit template most functionally alike to the unitary matrix). In any case, the parameter initialization can be considered or otherwise treated as a starting point for stochastic gradient descent to be performed on the given quantum circuit template. Contrast this with existing techniques that instead begin stochastic gradient descent from randomly initialized parameter values.

In various embodiments, the synthesis component can leverage the plurality of parameter initialization deep learning neural networks as follows. In various aspects, the synthesis component can identify which of the plurality of quantum circuit templates is ranked most highly in the template classification label (e.g., is ranked as most likely to be suitable for the synthesis or transpilation of the unitary matrix). In various instances, the synthesis component can identify which of the plurality of parameter initialization deep learning neural networks corresponds to that highest-ranked quantum circuit template. In various cases, the synthesis component can execute that identified parameter initialization deep learning neural network on the unitary matrix, and such execution can yield a parameter initialization for that highest-ranked quantum circuit template. In various aspects, the synthesis component can perform stochastic gradient descent on the highest-ranked quantum circuit template beginning or starting from the parameter initialization (as opposed to starting from random parameter values). In various instances, the objective function can be a complement of a fidelity (e.g., one minus fidelity) exhibited by the highest-ranked quantum circuit template with respect to the unitary matrix. If a threshold fidelity is reached within a threshold number of stochastic gradient descent iterations, then whatever specific parameter values were computed in the last or most recent stochastic gradient descent iteration can be considered as being the finalized or optimized parameter values that cause the highest-ranked quantum circuit template to approximate the unitary matrix. In other words, the highest-ranked quantum circuit template being filled with those finalized or optimized parameter values can be considered as the synthesized or transpiled version of the unitary matrix. In contrast, if the threshold fidelity is not reached within the threshold number of stochastic gradient descent iterations, then it can be concluded that the highest-ranked quantum circuit template is not able to approximate the unitary matrix. Accordingly, the synthesis component can identify a next-highest-ranked one of the plurality of quantum circuit templates as indicated by the template classification label, the synthesis component can obtain a non-random parameter initialization for that next-highest-ranked quantum circuit template via the plurality of parameter initialization deep learning neural networks, and the synthesis component can perform stochastic gradient descent on that next-highest-ranked quantum circuit template starting or beginning from that non-random parameter initialization. In various aspects, the synthesis component can repeat this procedure until a quantum circuit template is found that achieves the threshold fidelity within the threshold number of iterations (or until all of the plurality of quantum circuit templates have been found to be unable to achieve the threshold fidelity within the threshold number of iterations).

In this way, the unitary matrix can be synthesized or transpiled without excessive consumption of time. Indeed, various embodiments described herein can be considered as attempting (e.g., as performing stochastic gradient descent on) quantum circuit templates in an intelligent order (as determined by the template selection deep learning neural network) rather than in a random or guideless order. Thus, the likelihood of attempting very many quantum circuit templates that end up being unsuitable can be reduced. Additionally, the unitary matrix can be synthesized or transpiled without becoming trapped at local minima. After all, the intelligent parameter initializations of various embodiments described herein (produced by the plurality of parameter initialization deep learning neural networks) can be considered as placing the adjustable parameters of each attempted quantum circuit template close to their finalized or optimized values, and so the likelihood of encountering local minima can be greatly diminished.

In any case, whatever finalized or optimized parameter values are identified by the synthesis component for any of the plurality of quantum circuit templates can be inserted into, plugged into, or otherwise assigned to the adjustable parameters of that quantum circuit template. Accordingly, that quantum circuit template, as filled with those finalized or optimized parameter values, can be considered as being a synthesized or transpiled version of the unitary matrix. That is, such quantum circuit template, as filled with those finalized or optimized parameter values, can be considered as being (nearly) functionally equivalent to the unitary matrix, while also being able to be executed or performed on the quantum computer.

In various embodiments, the execution component of the computerized tool can take any suitable electronic actions, based on the synthesized or transpiled version of the unitary matrix. As a non-limiting example, the execution component can electronically command or instruct the quantum computer to execute or perform the synthesized or transpiled version of the unitary matrix. More specifically, the execution component can electronically replace, within the quantum payload circuit, the unitary matrix with the synthesized or transpiled version of the unitary matrix, thereby yielding a synthesized or transpiled version of the quantum payload circuit. Accordingly, the execution component can electronically command or instruct the quantum computer to execute or otherwise perform the synthesized or transpiled version of the quantum payload circuit (e.g., can initialize the qubits of the quantum computer in any suitable fashion, can cause those initialized qubits to perform whatever sequence of quantum operations is called for by the synthesized or transpiled version of the quantum payload circuit, and can cause whatever resultant quantum states are taken on by the qubits of the quantum computer to be read or measured).

Note that, in order for unitary synthesis to be accurately or correctly performed, the herein-described deep learning neural networks should first undergo training. In various cases, the computerized tool can train such deep learning neural networks using any suitable training paradigms (e.g., via supervised training, unsupervised training, or reinforcement learning).

Various embodiments described herein can be employed to use hardware or software to solve problems that are highly technical in nature (e.g., to facilitate intelligent unitary synthesis for quantum computing), that are not abstract and that cannot be performed as a set of mental acts by a human. Further, some of the processes performed can be performed by a specialized computer (e.g., quantum computers comprising tangible qubits that can execute or implement quantum circuits; deep learning neural networks that are configured to classify or perform regression for unitary matrices).

In various aspects, some defined tasks associated with various embodiments described herein can include: accessing, by a device operatively coupled to a processor, a unitary matrix of a quantum payload circuit, wherein the unitary matrix is outside of design constraints of an architecture of a quantum computer; and synthesizing, by the device, the unitary matrix into a transpiled unitary matrix that is within the design constraints of the architecture of the quantum computer, based on deep learning initialization of adjustable parameters of quantum circuit templates. In some instances, such defined tasks can further include: replacing, by the device, the unitary matrix in the quantum payload circuit with the transpiled unitary matrix, thereby yielding a transpiled quantum payload circuit; and executing, by the device, the transpiled quantum payload circuit on the quantum computer. In various cases, a plurality of quantum circuit templates can be within the design constraints of the architecture of the quantum computer, and the synthesizing can involve: ranking, by the device and via execution of a first deep learning neural network, the plurality of quantum circuit templates in order of suitability with respect to the unitary matrix; initializing, by the device and via execution of a second deep learning neural network corresponding to a highest-ranking quantum circuit template from the plurality of quantum circuit templates, one or more first adjustable parameters of the highest-ranking quantum circuit template; performing, by the device, gradient descent optimization on the one or more first adjustable parameters starting from one or more first initialized values produced by the second deep learning neural network until a threshold fidelity is achieved, thereby yielding the transpiled unitary matrix; in response to the threshold fidelity not being achieved after a threshold number of iterations, initializing, by the device and via execution of a third deep learning neural network corresponding to a next-highest-ranking quantum circuit template from the plurality of quantum circuit templates, one or more second adjustable parameters of the next-highest-ranking quantum circuit template; and performing, by the device, gradient descent optimization on the one or more second adjustable parameters starting from one or more second initialized values produced by the third deep learning neural network until the threshold fidelity is achieved, thereby yielding the transpiled unitary matrix.

Neither the human mind nor a human with pen and paper can: electronically access a unitary matrix of a quantum circuit; electronically execute a first neural network on that unitary matrix so as to rank a collection of available circuit templates for synthesis or transpilation suitability; electronically select circuit templates to attempt for synthesis or transpilation in order of decreasing synthesis or transpilation suitability; electronically execute one or more second neural networks on that unitary matrix so as to obtain respective non-random parameter initializations for selected circuit templates; electronically perform stochastic gradient descent on selected circuit templates starting or beginning from those non-random parameter initializations, thereby yielding a synthesized or transpiled version of the unitary matrix; and electronically cause the synthesized or transpiled version of the unitary matrix to be executed or performed on the quantum computer.

After all, a quantum computer is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum computer.

Neither the human mind, nor a human with pen and paper, can transpile or otherwise manipulate quantum gates or execute quantum gates on physical qubits. Additionally, artificial neural networks are also inherently computerized constructs comprising specific software-oriented architectures (e.g., input layers, hidden layers, or output layers, any of which can be made up of trainable or non-trainable internal parameters such as convolutional layers or LSTM layers). Artificial neural networks cannot be trained or executed by the human mind, or by humans with mere pen and paper, in any reasonable or practicable way without computers. Also, the very field of quantum circuit transpilation is focused on electronically translating or reformatting quantum circuits so that they can be implementable or executable on specific quantum hardware. It would make no sense whatsoever to discuss the field of quantum circuit transpilation outside of a computing context. Therefore, a computerized tool that can facilitate unitary synthesis or transpilation via implementation of intelligent template selection or intelligent parameter initialization is inherently computerized and cannot be implemented in any sensible, practicable, or reasonable way without computers.

In various instances, one or more embodiments described herein can integrate the herein-described teachings into a practical application. As mentioned above, some existing techniques facilitate unitary synthesis or transpilation in exact fashion (e.g., KAK-based decomposition, Quantum Shannon Decomposition). Unfortunately, such existing techniques cannot be applied to unitary matrices that operate on more than two qubits. As also mentioned above, other existing techniques facilitate unitary synthesis or transpilation in approximate fashion by leveraging circuit templates. Although such other existing techniques are applicable to unitary matrices that operate on more than two qubits, the present inventors recognized that such other existing techniques nevertheless suffer from various technical problems.

Specifically, the present inventors realized that such other existing techniques can consume excessive amounts of time and are prone to failure due to local minima entrapment. Indeed, the present inventors recognized that, when given multiple circuit templates, existing techniques provide no specific strategy whatsoever for deciding in which order such multiple circuit templates should be attempted or chosen for unitary synthesis or transpilation. Instead, such existing techniques use a random order for attempting or choosing circuit templates. As the present inventors realized, such random order can often cause very many unsuitable circuit templates (e.g., templates that are incapable of achieving a threshold fidelity with respect to a desired unitary matrix) to be attempted or chosen before a suitable circuit template is attempted or chosen. Time spent on circuit templates that end up proving to be unsuitable can be considered as wasted, and so the random template selection order of existing techniques can be considered as undesirable. Additionally, for any given circuit template that has been chosen for a synthesis or transpilation attempt, existing techniques perform stochastic gradient descent on that given circuit template starting from a random parameter initialization. As the present inventors recognized, such random parameter initialization can exacerbate the time-consumption of existing techniques. That is, when starting from random parameter values, it can take significantly longer (e.g., it can require many thousands more iterations) to converge to optimized parameter values (e.g., to converge to parameter values that achieve a threshold fidelity with respect to a desired unitary matrix). As the present inventors also recognized, such random parameter initialization can cause stochastic gradient descent to become unacceptably prone to being trapped at local minima. Thus, even if a circuit template is capable of achieving a threshold fidelity with respect to a desired unitary matrix, stochastic gradient descent of existing techniques might nevertheless fail to converge upon the specific parameter values that would cause that circuit template to achieve the threshold fidelity.

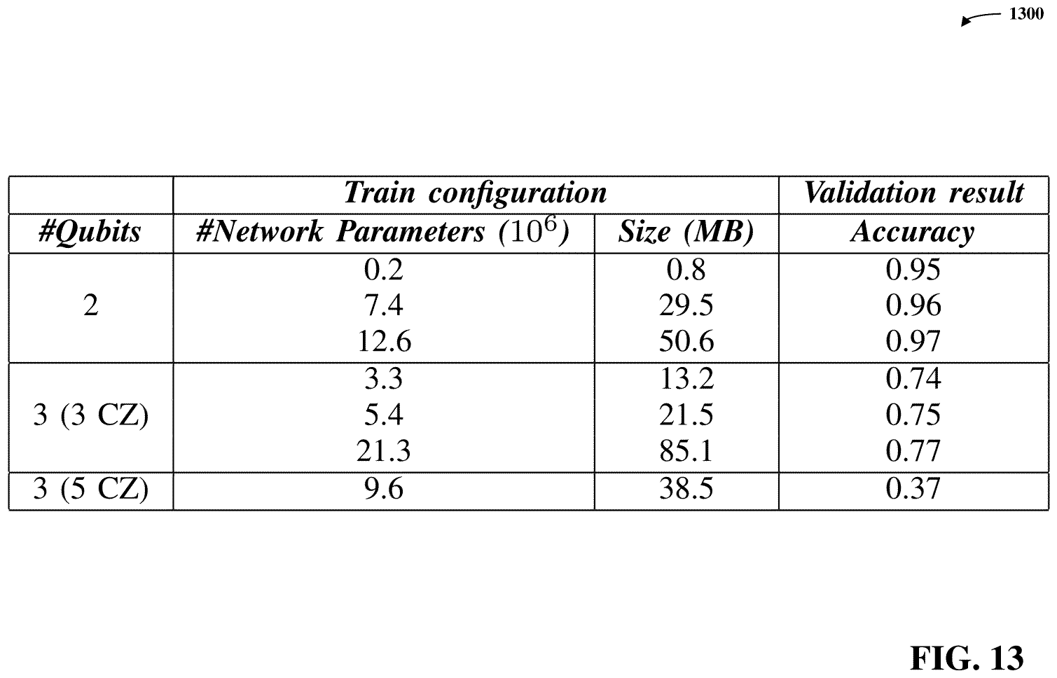

Accordingly, the present inventors devised various embodiments described herein, which can be considered as solving, addressing, or otherwise ameliorating the technical problems that afflict such existing techniques. In particular, various embodiments described herein can include leveraging deep learning so as to enhance or improve the efficacy of approximate unitary synthesis or transpilation. More specifically, when given multiple circuit templates, various embodiments described herein can involve utilizing deep learning so as to intelligently select or choose which of those multiple circuit templates are most likely to be suitable for a desired unitary matrix (e.g., so as to determine which of those circuit templates are most likely to be capable of achieving a threshold fidelity with respect to the desired unitary matrix). Contrast this with existing techniques that instead randomly select or choose which circuit templates to attempt or try. Additionally, when given a particular circuit template having various adjustable parameters, various embodiments described herein can involve utilizing deep learning so as to intelligently initialize those adjustable parameters at non-random values that increase the likelihood of quick convergence or that decrease the likelihood of local minima entrapment. Contrast this with existing techniques, that instead perform stochastic gradient descent starting from randomly initialized parameter values. Thus, by implementing intelligent template selection or intelligent parameter initialization, various embodiments described herein can facilitate unitary synthesis or transpilation in less time or with less risk of local minima entrapment than existing techniques. In fact, these benefits were even experimentally verified by the present inventors, as described with respect to FIGS. 13-16. For at least these reasons, various embodiments described herein constitute concrete and tangible technical improvements or technical effects in the field of quantum circuit transpilation and thus certainly qualify as useful and practical applications of computers.

It should be appreciated that the figures and the herein disclosure describe non-limiting examples of various embodiments. It should further be appreciated that the figures are not necessarily drawn to scale.

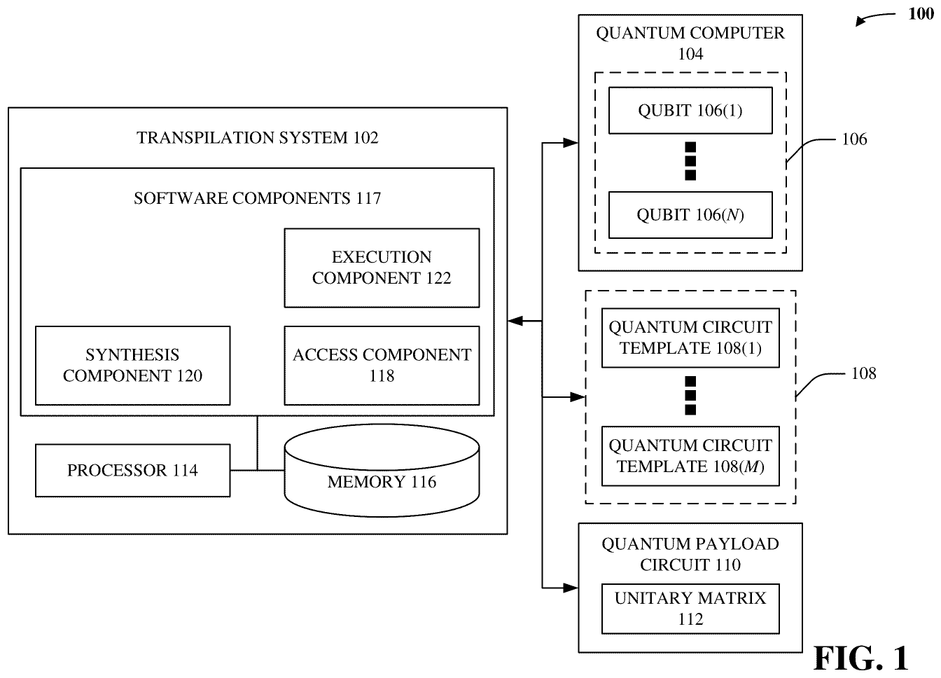

FIG. 1 illustrates a block diagram of an example, non-limiting system 100 that can facilitate intelligent unitary synthesis for quantum computing in accordance with one or more embodiments described herein. As shown, a transpilation system 102 can be electronically integrated, via any suitable wired or wireless electronic connections, with a quantum computer 104, with a plurality of quantum circuit templates 108, or with a quantum payload circuit 110.

In various embodiments, the quantum computer 104 can be any suitable quantum computing device or quantum computing hardware. In various aspects, the quantum computer 104 can comprise or otherwise include a set of qubits 106. In various instances, the set of qubits 106 can have n qubits for any suitable positive integer n: a qubit 106(1) to a qubit 106(n). In various cases, any of the set of qubits 106 can exhibit any suitable structure or architecture. As a non-limiting example, any of such qubits can exhibit a superconducting qubit architecture (e.g., such qubit can be constructed from any suitable number of Josephson junctions shunted by any suitable number of planar capacitor pads). As another non-limiting example, any of such qubits can exhibit a quantum dot architecture. As yet another non-limiting example, any of such qubits can exhibit a spin qubit architecture. In various aspects, different qubits of the set of qubits 106 can exhibit the same or different structures or architectures as each other. Although not explicitly shown in FIG. 1, the quantum computer 104 can comprise or otherwise be associated with any suitable hardware or software (e.g., real-time controllers implemented in field programmable gate arrays of the quantum computer 104) that can be used to initialize any of the set of qubits 106, or that can be used to perform any suitable quantum operations (e.g., quantum gates, qubit measurements, qubit idling) on the set of qubits 106.

In various embodiments, the quantum payload circuit 110 can be any suitable sequence of any suitable types of quantum gates (e.g., Pauli gates, Hadamard gates, Phase gates, entangling gates) that can be executed in parallel or in series on the set of qubits 106. Accordingly, the quantum payload circuit 110 can be considered as being an n-qubit circuit (e.g., as being a circuit that can operate on n qubits, as being an n-order tensor product; as being a 2″×2″matrix). In various instances, as shown, the quantum payload circuit 110 can comprise or otherwise include a unitary matrix 112. In other words, the unitary matrix 112 can be any suitable constituent part or portion of the quantum payload circuit 110 that qualifies as unitary (e.g., any suitable square matrix whose inverse is its conjugate transpose). In some cases, the unitary matrix 112 can be an n-qubit operator. However, in other aspects, the unitary matrix 112 can be smaller than an n-qubit operator (e.g., can be configured to operate on fewer than n qubits).

In any case, the unitary matrix 112 can be currently or presently formatted so as to not be implementable, executable, or performable on the quantum computer 104. In other words, the unitary matrix 112 can specify one or more quantum gates that cannot be performed by the hardware of the quantum computer 104. In still other words, one or more quantum gates of the unitary matrix 112 can be considered as failing to fit within or comply with any suitable design constraints associated with the architecture (e.g., with the coupling topology) of the quantum computer 104. In some cases, it can be physically or theoretically impossible to execute or perform the unitary matrix 112 on the architecture of the quantum computer 104. In such situations, the unitary matrix 112 can certainly be considered as not implementable on, or as falling outside of design constraints of, the architecture of the quantum computer 104. However, in other cases, it can be physically or theoretically possible to execute or perform the unitary matrix 112 on the architecture of the quantum computer 104, but such execution or performance can be exceedingly inconvenient or burdensome. Thus, in such situations, the unitary matrix 112 can also be considered as not implementable on, or as falling outside of design constraints of, the architecture of the quantum computer 104.

As a non-limiting example, suppose that the unitary matrix 112 specifies or includes an entangling gate between a qubit A and a qubit B of the quantum computer 104, where the qubit A and the qubit B are not coupled together. Further suppose that the coupling topology of the quantum computer 104 is such that there is no possible combination of SWAP gates that could ever cause the logical state of the qubit A and the logical state of the qubit B to occupy two qubits of the quantum computer 104 that are coupled together. In such case, it can be impossible to perform or execute the unitary matrix 112 as currently or presently formatted on the quantum computer 104. Thus, the unitary matrix 112 can be considered as falling outside of the design constraints of the architecture of the quantum computer 104. Now, instead suppose that the coupling topology of the quantum computer 104 is such that at least one combination of SWAP gates can cause the logical state of the qubit A and the logical state of the qubit B to occupy two qubits of the quantum computer 104 that are coupled together. In such case, it can be theoretically possible to perform or execute the unitary matrix 112 as currently or presently formatted on the quantum computer 104. However, such performance or execution would likely necessitate a complicated, convoluted, or otherwise burdensome arrangement of SWAP gates. Thus, notwithstanding being theoretically performable or executable, the unitary matrix 112 in such case can nevertheless be considered as falling outside of the design constraints of the architecture of the quantum computer 104.

In various embodiments, the plurality of quantum circuit templates 108 can comprise, have, or otherwise possess m templates, for any suitable positive integer m>1: a quantum circuit template 108(1) to a quantum circuit template 108(m). In various aspects, each of the plurality of quantum circuit templates 108 can be any suitable quantum circuit that is configured to operate on the same number of qubits as the unitary matrix 112. So, if the unitary matrix 112 is an n-qubit operator, then each of the plurality of quantum circuit templates 108 can likewise be configured to operate on n qubits. Moreover, in various instances, each of the plurality of quantum circuit templates 108 can be implementable on, executable on, performable by, supported by, or otherwise within design constraints of the architecture of the quantum computer 104. In other words, each of the plurality of quantum circuit templates 108 can be composed or made up of any suitable single-qubit gates (e.g., Pauli-X gates, Pauli-Y gates, Pauli-Z gates, Hadamard gates, Phase gates, Rotation gates) or any suitable two-qubit entangling gates (e.g., Controlled-NOT gates, Controlled-Y gates, Controlled-Z gates) that are supported by the hardware (e.g., by the coupling topology) of the quantum computer 104. As a non-limiting example, any entangling gate that is specified or called for by any of the plurality of quantum circuit templates 108 can be between two qubits of the quantum computer 104 that are coupled together. Stated differently, none of the plurality of quantum circuit templates 108 can specify or call for an entangling gate that is between two qubits of the quantum computer 104 that are not coupled together. Furthermore, each of the plurality of quantum circuit templates 108 can have or otherwise possess any suitable number of adjustable parameters, where an adjustable parameter of a quantum circuit template can be any suitable property, attribute, or characteristic of the quantum circuit template which can be selectively or controllably altered, changed, varied, or otherwise adjusted.

As a non-limiting example, the quantum circuit template 108(1) can be a first quantum circuit having a first fixed number of single-qubit gates and a first fixed number of two-qubit gates which are arranged in any suitable fixed layout or sequential order with respect to each other. Some of the single-qubit gates that make up the quantum circuit template 108(1) can be Rotation gates (e.g., an RZ gate, which can be considered as a rotation about a z-axis). In various instances, the respective amount of rotation associated with or performed by each of those Rotation gates can be variable and thus can be considered as a respective adjustable parameter of the quantum circuit template 108(1). So, if the quantum circuit template 108(1) contains a total of r₁ Rotation gates, for any suitable positive integer r₁, then the quantum circuit template 108(1) can be considered as having a total of r₁ adjustable parameters (e.g., a total of r₁ angular rotation variables). Note that, because the quantum circuit template 108(1) can have the same dimensionality as the unitary matrix 112, the single-qubit and two-qubit gates of the quantum circuit template 108(1) can, when combined or simplified via matrix or tensor multiplication, be considered as forming an n-qubit (or smaller) quantum operator (e.g., as forming a square matrix having dimensions 2″×2″ or smaller).

As another non-limiting example, the quantum circuit template 108(m) can be an m-th quantum circuit having an m-th fixed number of single-qubit gates and an m-th fixed number of two-qubit gates which are arranged in any suitable fixed layout or sequential order with respect to each other. As above, some of the single-qubit gates that make up the quantum circuit template 108(m) can be Rotation gates, and so the respective amount of rotation associated with or performed by each of those Rotation gates can be variable and thus can be considered as a respective adjustable parameter of the quantum circuit template 108(m). So, if the quantum circuit template 108(m) contains a total of rₘ Rotation gates, for any suitable positive integer rₘ, then the quantum circuit template 108(m) can be considered as having a total of rₘ adjustable parameters (e.g., a total of rₘ angular rotation variables). Also as above, because the quantum circuit template 108(m) can have the same dimensionality as the unitary matrix 112, the single-qubit and two-qubit gates of the quantum circuit template 108(m) can, when combined or simplified via matrix or tensor multiplication, be considered as forming an n-qubit (or smaller) quantum operator.

Note that different ones of the plurality of quantum circuit templates 108 can have the same or different numbers or types of adjustable parameters as each other. More generally, note that different ones of the plurality of quantum circuit templates 108 can have the same or different numbers or arrangements of single-qubit gates or two-qubit gates as each other.

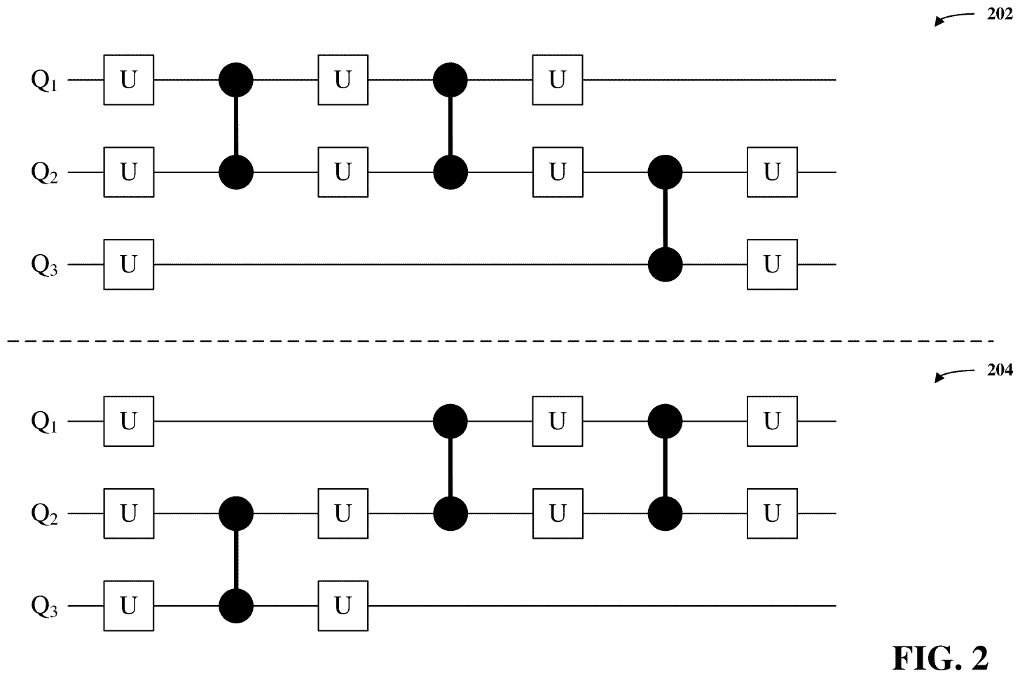

FIG. 2 illustrates example, non-limiting circuit diagrams of quantum circuit templates in accordance with one or more embodiments described herein. Specifically, FIG. 2 shows a quantum circuit template 202 and a quantum circuit template 204. In the non-limiting example of FIG. 2, each of the quantum circuit template 202 and the quantum circuit template 204 are configured to operate on three qubits, which are denoted in shorthand notation via “Q₁”, “Q₂”, and “Q₃”. That is, in the non-limiting example of FIG. 2, the unitary matrix 112 can be a 3-qubit operator. As shown, the quantum circuit template 202 includes a particular arrangement of three Controlled-Z gates and nine single-qubit gates each denoted as “U”. Note that such nine single-qubit gates are denoted as “U” merely for ease of illustration. It should be understood that any of such nine single-qubit gates can be different from each other. As some non-limiting examples, any of such nine single-qubit gates can be Pauli-X gates (X), Pauli-Y gates (Y), Pauli-Z gates (Z), Hadamard gates (H), Phase gates(S), Z-Rotation gates (RZ), X-Rotation gates (RX), Y-Rotation gates (RY), or any suitable series or combination thereof. However, in other cases, such nine single-qubit gates can all have the same structure or layout as each other. As a non-limiting example, each of such nine single-qubit gates can be three RZ gates that are separated by two SX gates, where SX can enact a 90-degree rotation about the x-axis. In such situation, the quantum circuit template 202 can be considered as having a total of 27 adjustable parameters (e.g., nine single-qubit gates denoted “U”, with each “U” having three adjustable or variable z-axis rotation angles). As shown, the quantum circuit template 204 can exhibit a different layout or arrangement of gates than the quantum circuit template 202.

Referring back to FIG. 1, it can be desired to synthesize or transpile the unitary matrix 112 into a format that is supported by or executable on the architecture of the quantum computer 104. As described herein, the transpilation system 102 can facilitate such synthesis or transpilation.

In various embodiments, the transpilation system 102 can comprise a processor 114 (e.g., computer processing unit, microprocessor) and a non-transitory computer-readable memory 116 that is operably connected or coupled to the processor 114. The memory 116 can store computer-executable instructions which, upon execution by the processor 114, can cause the processor 114 or other components of the transpilation system 102 (e.g., access component 118, synthesis component 120, execution component 122) to perform one or more acts. In various embodiments, the memory 116 can store computer-executable components (e.g., access component 118, synthesis component 120, execution component 122), and the processor 114 can execute the computer-executable components.

In various embodiments, the transpilation system 102 can comprise an access component 118. In various aspects, the access component 118 can electronically access, in any suitable fashion, the quantum computer 104, such that the transpilation system 102 can electronically activate (e.g., power-up), electronically deactivate (e.g., power-down), or otherwise electronically control the quantum computer 104. Furthermore, in various instances, the access component 118 can electronically receive, retrieve, obtain, import, or otherwise access, from any suitable data structures or from any suitable computing devices, the plurality of quantum circuit templates 108 or the quantum payload circuit 110. In any case, the access component 118 can electronically access (e.g., send or receive data or program instructions to or from) the quantum computer 104, the plurality of quantum circuit templates 108, or the quantum payload circuit 110, such that other components of the transpilation system 102 can electronically interact with the quantum computer 104, with the plurality of quantum circuit templates 108, or with the quantum payload circuit 110.

In various embodiments, the transpilation system 102 can comprise a synthesis component 120. In various aspects, the synthesis component 120 can, as described herein, leverage deep learning so as to synthesize or transpile the unitary matrix 112 into a format that is supported by the quantum computer 104, based on the plurality of quantum circuit templates 108.

In various embodiments, the transpilation system 102 can comprise an execution component 122. In various instances, the execution component 122 can, as described herein, cause the synthesized or transpiled version of the unitary matrix 112 to be executed or performed by the quantum computer 104.

Note that, in various instances, the access component 118, the synthesis component 120, and the execution component 122 can collectively be considered as being one or more software components 117 of the transpilation system 102. In various aspects, it should be appreciated that the one or more software components 117 are described primarily herein as comprising three components (e.g., the access component 118, the synthesis component 120, and the execution component 122) for ease of explanation and illustration. However, the one or more software components 117 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the access component 118, the synthesis component 120, and the execution component 122). In other embodiments, the functionalities described herein of such three components can instead be distributed, separated, split, or fragmented in any suitable fashions, so as to be implemented in or by more than three components (e.g., two or more components can facilitate the functionalities that are performable by the access component 118; two or more components can facilitate the functionalities that are performable by the synthesis component 120; two or more components can facilitate the functionalities that are performable by the execution component 122).

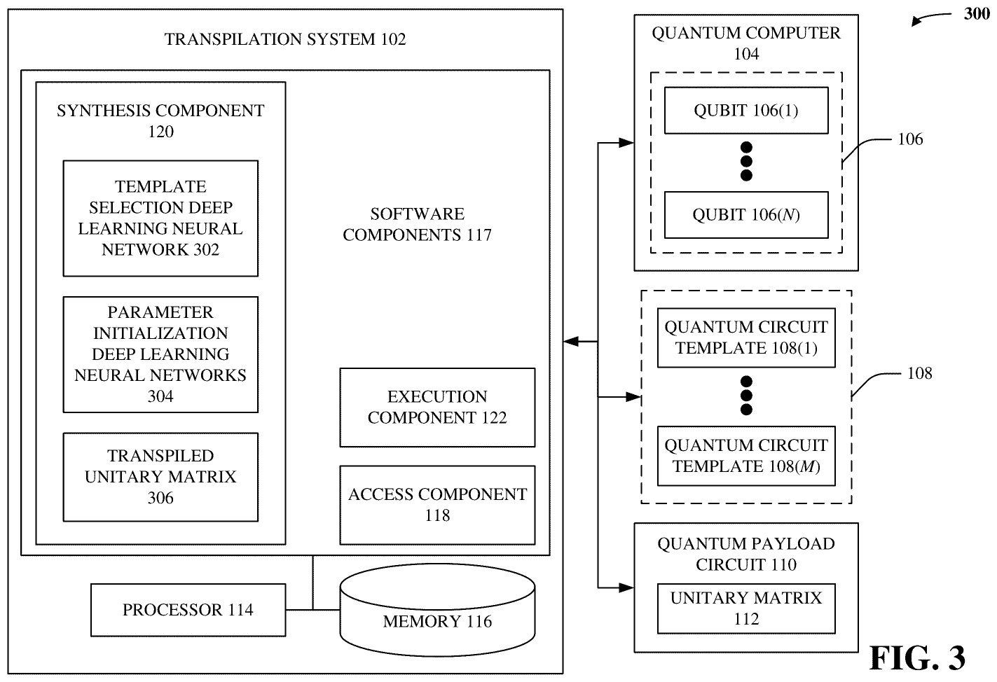

FIG. 3 illustrates a block diagram of an example, non-limiting system 300 including a template selection deep learning neural network, a plurality of parameter initialization deep learning neural networks, and a transpiled unitary matrix that can facilitate intelligent unitary synthesis for quantum computing in accordance with one or more embodiments described herein. As shown, the system 300 can, in some cases, comprise the same components as the system 100, and can further comprise a template selection deep learning neural network 302, a plurality of parameter initialization deep learning neural networks 304, or a transpiled unitary matrix 306.

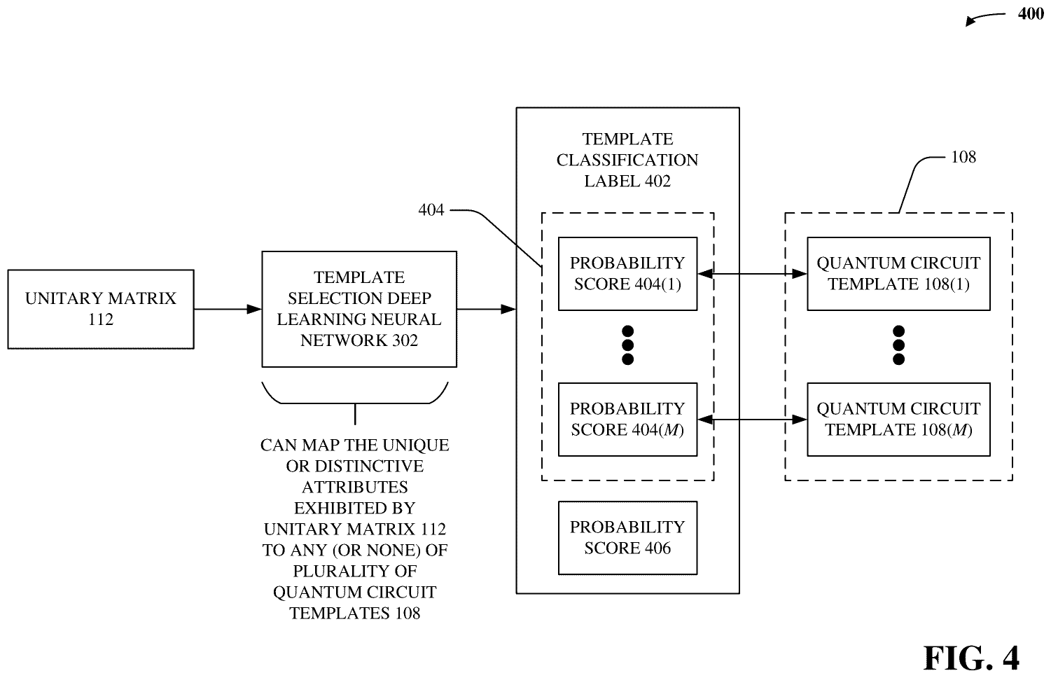

In various aspects, the transpiled unitary matrix 306 can be considered as a functionally equivalent (to within any suitable threshold fidelity) version of the unitary matrix 112 that is executable, implementable, or performable on the quantum computer 104. In other words, the transpiled unitary matrix 306 can be considered as a reformatted or rewritten version of the unitary matrix 112, which reformatted or rewritten version is supported by the topology or hardware of the quantum computer 104. In various instances, as described herein, the synthesis component 120 can generate the transpiled unitary matrix 306, by leveraging the template selection deep learning neural network 302 and the plurality of parameter initialization deep learning neural networks 304. Non-limiting aspects are described with respect to FIGS. 4-8.

FIGS. 4-8 illustrate example, non-limiting block diagrams showing how the template selection deep learning neural network 302 and the plurality of parameter initialization deep learning neural networks 304 can be leveraged to generate the transpiled unitary matrix 306 in accordance with one or more embodiments described herein.

First, consider FIG. 4. In various embodiments, the synthesis component 120 can electronically store, maintain, control, or otherwise access the template selection deep learning neural network 302. In various aspects, the template selection deep learning neural network 302 can exhibit any suitable deep learning internal architecture. Indeed, in various cases, the template selection deep learning neural network 302 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of its specific internal architecture (e.g., of its specific numbers, types, or organizations of layers), the template selection deep learning neural network 302 can be configured to determine the synthesis or transpilation suitability of each of the plurality of quantum circuit templates 108 with respect to any inputted unitary operator. Accordingly, the synthesis component 120 can execute the template selection deep learning neural network 302 on the unitary matrix 112, and such execution can cause the template selection deep learning neural network 302 to produce a template classification label 402. More specifically, the synthesis component 120 can feed the unitary matrix 112 to the input layer of the template selection deep learning neural network 302. In various cases, the unitary matrix 112 can complete a forward pass through the one or more hidden layers of the template selection deep learning neural network 302. In various aspects, the output layer of the template selection deep learning neural network 302 can compute or calculate the template classification label 402 based on activation maps or feature maps produced by the one or more hidden layers of the template selection deep learning neural network 302.

In various aspects, the template classification label 402 can be any suitable electronic data (e.g., can be one or more scalars, one or more vectors, one or more matrices, one or more tensors, one or more character strings, or any suitable combination thereof) that can rank the plurality of quantum circuit templates 108 in terms of their respective capabilities to successfully be used to synthesize or transpile the unitary matrix 112. In particular, the template classification label 402 can comprise a plurality of probability scores 404 that respectively correspond (e.g., in one-to-one fashion) to the plurality of quantum circuit templates 108. Thus, since the plurality of quantum circuit templates 108 can have m templates, the plurality of probability scores 404 can likewise have m scores; a probability score 404(1) to a probability score 404(m). In various cases, each of the plurality of probability scores 404 can be a real-valued scalar that indicates a likelihood (as inferred by the template selection deep learning neural network 302) that the unitary matrix 112 can be successfully synthesized or transpiled by using a respective one of the plurality of quantum circuit templates 108. As a non-limiting example, the probability score 404(1) can be a first scalar estimated by the template selection deep learning neural network 302 and whose value (e.g., ranging from 0 to 1 , or from 0 % to 100 %) indicates a likelihood that the unitary matrix 112 can be successfully (e.g., with a threshold amount of fidelity) synthesized or transpiled by using the quantum circuit template 108(1). As another non-limiting example, the probability score 404(m) can be an m-th scalar estimated by the template selection deep learning neural network 302 and whose value indicates a likelihood that the unitary matrix 112 can be successfully synthesized or transpiled by using the quantum circuit template 108(m).

In some cases, as shown, the template classification label 402 can include a probability score 406 which can indicate a likelihood (as inferred by the template selection deep learning neural network 302) that the unitary matrix 112 cannot be successfully synthesized or transpiled by any of the plurality of quantum circuit templates 108.

Note that, in some instances, the plurality of probability scores 404 (in conjunction with the probability score 406, if applicable) can be not independent of each other. As a non-limiting example, the plurality of probability scores 404 can be restricted such that their total sum (including the probability score 406 if applicable) can be unity (e.g., can be 1 or 100 %).

In any case, the template classification label 402 can be considered as ranking the plurality of quantum circuit templates 108 in order of synthesis or transpilation suitability with respect to the unitary matrix 112 (e.g., templates having higher probability scores can be considered as more likely to be suitable for the unitary matrix 112; templates having lower probability scores can be considered as being less likely to be suitable for the unitary matrix 112). In other words, the template selection deep learning neural network 302 can be considered as mapping or correlating the unique or distinctive attributes or characteristics of the unitary matrix 112 more heavily to some of the plurality of quantum circuit templates 108 and less heavily to others of the plurality of quantum circuit templates 108.

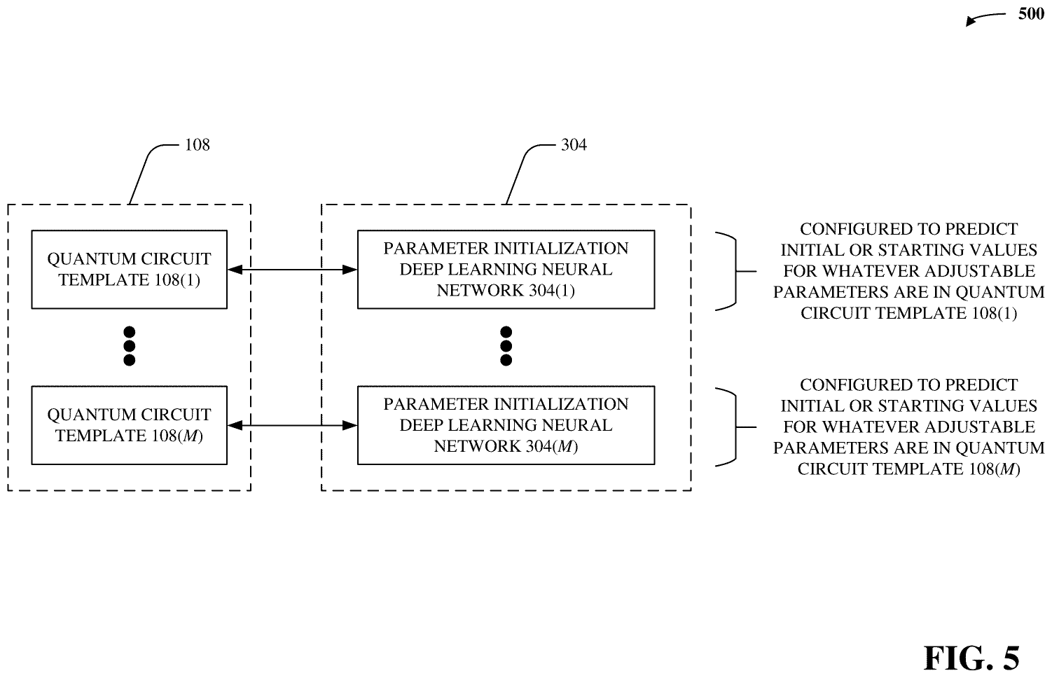

Now, consider FIG. 5. In various embodiments, the synthesis component 120 can electronically store, maintain, control, or otherwise access the plurality of parameter initialization deep learning neural networks 304. In various aspects, each of the plurality of parameter initialization deep learning neural networks 304 can exhibit any suitable deep learning internal architecture. Indeed, in various cases, any of the plurality of parameter initialization deep learning neural networks 304 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of its specific internal architecture, each of the plurality of parameter initialization deep learning neural networks 304 can be configured as a regressor that predicts whatever specific values the adjustable parameters of a respective one of the plurality of quantum circuit templates 108 should be initialized to, so as to synthesize or transpile any inputted unitary operator. As a non-limiting example, the parameter initialization deep learning neural network 304(1) can be configured to predict initial or starting values for whatever adjustable parameters (e.g., for whatever variable rotation angles) are in the quantum circuit template 108(1), when given an inputted unitary operator (e.g., so as to maximize a fidelity exhibited by the quantum circuit template 108(1) with respect to that inputted unitary operator). As another non-limiting example, the parameter initialization deep learning neural network 304(m) can be configured to predict initial or starting values for whatever adjustable parameters are in the quantum circuit template 108(m), when given an inputted unitary operator (e.g., so as to maximize a fidelity exhibited by the quantum circuit template 108(m) with respect to that inputted unitary operator). Note that, in some instances, any layers of any of the plurality of parameter initialization deep learning neural networks 304 can be complex-valued as appropriate or as desired. Indeed, rotation angles of qubit rotation gates can take on complex values, not just real values. Accordingly, in some instances, any layers of any of the plurality of parameter initialization deep learning neural networks 304 can be configured to operate on or compute complex values.

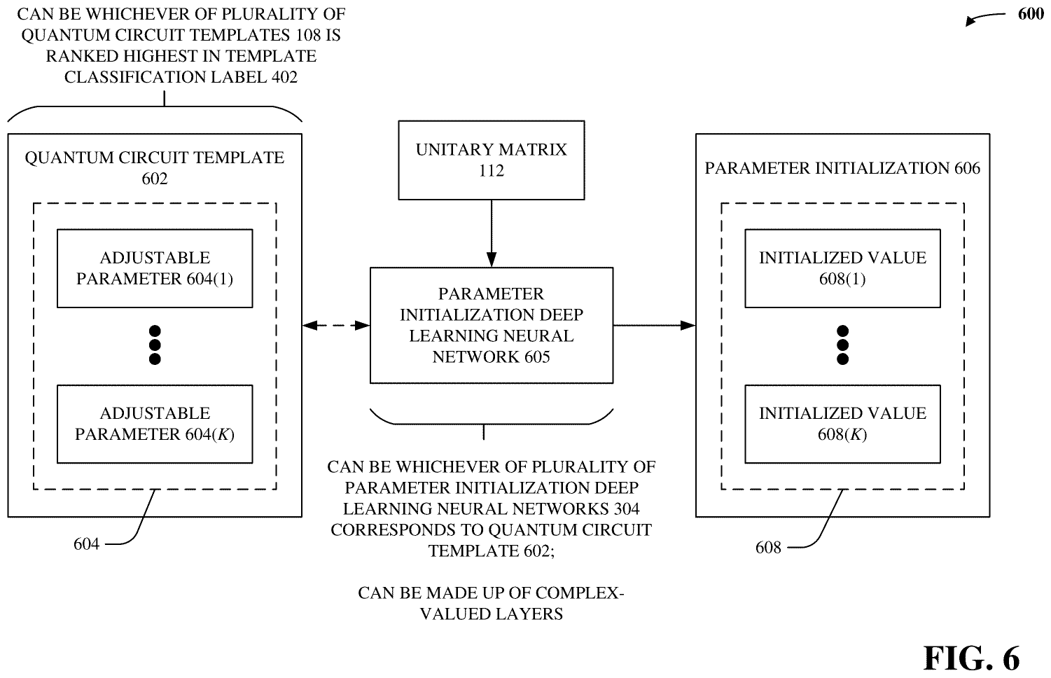

Next, consider FIG. 6. In situations where the probability score 406 is not greater than each of the probability scores 404, the synthesis component 120 can identify whichever of the plurality of quantum circuit templates 108 is ranked highest in the template classification label 402 (e.g., can identify which quantum circuit template is associated with a highest probability score). Such highest-ranking quantum circuit template can be referred to as a quantum circuit template 602. As shown, the quantum circuit template 602 can have or otherwise possess a set of adjustable parameters 604 (e.g., a set of variable single-qubit rotation angles). In various instances, the set of adjustable parameters 604 can include k parameters, for any suitable positive integer k: an adjustable parameter 604(1) to an adjustable parameter 604(k).

In various aspects, the synthesis component 120 can identify whichever of the plurality of parameter initialization deep learning neural networks 304 corresponds to the quantum circuit template 602. This can be referred to as a parameter initialization deep learning neural network 605. In various instances, the synthesis component 120 can execute the parameter initialization deep learning neural network 605 on the unitary matrix 112, and such execution can cause the parameter initialization deep learning neural network 605 to produce a parameter initialization 606. More specifically, the synthesis component 120 can feed the unitary matrix 112 to the input layer of the parameter initialization deep learning neural network 605. In various cases, the unitary matrix 112 can complete a forward pass through the one or more hidden layers of the parameter initialization deep learning neural network 605. In various aspects, the output layer of the parameter initialization deep learning neural network 605 can compute or calculate the parameter initialization 606 based on activation maps or feature maps produced by the one or more hidden layers of the parameter initialization deep learning neural network 605.

In various instances, the parameter initialization 606 can be any suitable electronic data (e.g., can be one or more scalars, one or more vectors, one or more matrices, one or more tensors, one or more character strings, or any suitable combination thereof) that indicates specific initial, starting, or beginning values for the adjustable parameters of the quantum circuit template 602, which values the parameter initialization deep learning neural network 605 believes will maximize a fidelity exhibited by the quantum circuit template 602 with respect to the unitary matrix 112. More specifically, the parameter initialization 606 can comprise or include a set of initialized values 608 that can respectively correspond (e.g., in one-to-one fashion) to the set of adjustable parameters 604. Thus, since the set of adjustable parameters 604 can have k parameters, the set of initialized values 608 can have k values: an initialized value 608(1) to an initialized value 608(k). In various aspects, each of the set of initialized values 608 can be a complex number which can be assigned to or taken on by a respective one of the set of adjustable parameters 604. As a non-limiting example, the initialized value 608(1) can be a complex number which the parameter initialization deep learning neural network 605 believes should be initially assigned to the adjustable parameter 604(1), so as to help cause the quantum circuit template 602 to successfully approximate the unitary matrix 112. As another non-limiting example, the initialized value 608(k) can be a complex number which the parameter initialization deep learning neural network 605 believes should be initially assigned to the adjustable parameter 604(k), so as to help cause the quantum circuit template 602 to successfully approximate the unitary matrix 112.

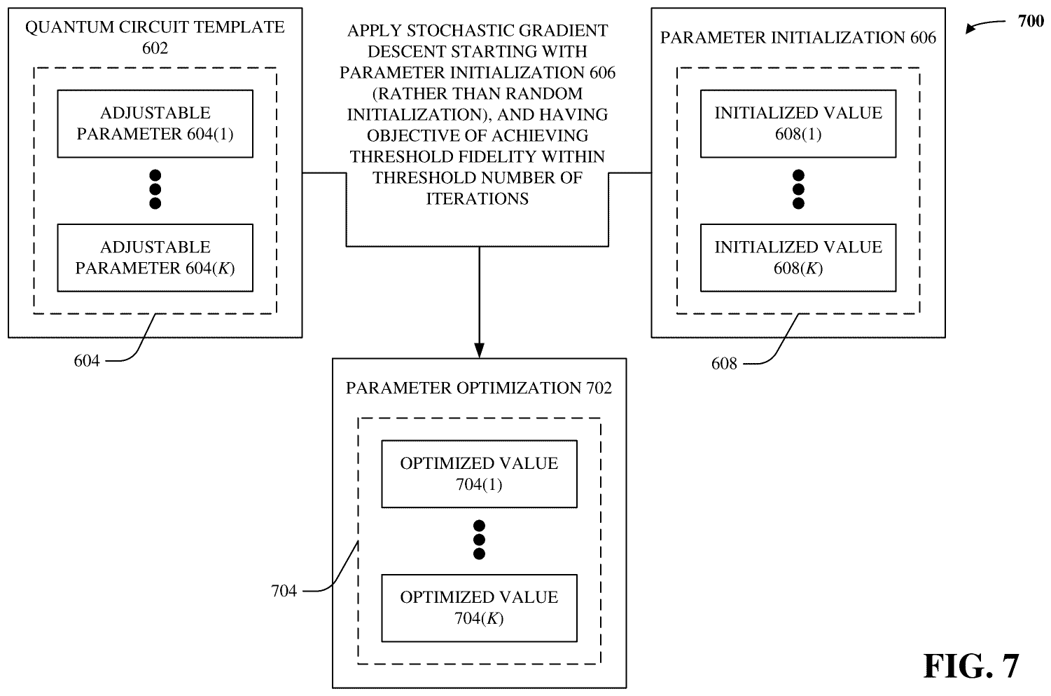

Now, consider FIG. 7. In various embodiments, the synthesis component 120 can electronically apply stochastic gradient descent (or any other suitable gradient descent or ascent optimization technique) to the quantum circuit template 602, starting or beginning with the parameter initialization 606. That is, rather than starting or beginning such stochastic gradient descent technique by first assigning random values to the set of adjustable parameters 604, the synthesis component 120 can instead start or begin such stochastic gradient descent technique by assigning the set of initialized values 608 to the set of adjustable parameters 604. More specifically, the synthesis component 120 can assign the initialized value 608(1) to the adjustable parameter 604(1) and can assign the initialized value 608(k) to the adjustable parameter 604(k). The synthesis component 120 can then compute, calculate, or otherwise determine an error or loss between the quantum circuit template 602 and the unitary matrix 112. In some cases, such error or loss can be equal to a complement of (e.g., one minus) a fidelity that the quantum circuit template 602 exhibits with respect to the unitary matrix 112. In such situations, the fidelity can be measured in any suitable fashion, such as via quantum state tomography or benchmarking. In various instances, the synthesis component 120 can incrementally update each of the set of adjustable parameters 604 by backpropagating the error or loss via any suitable gradient computations. The synthesis component 120 can repeat such actions (e.g., measuring fidelity and then incrementally updating the set of adjustable parameters 604) until the measured fidelity satisfies (e.g., is greater than) any suitable threshold fidelity value.

At such point, the finally or most recently updated values of the set of adjustable parameters 604 can be considered as forming a parameter optimization 702. More specifically, the parameter optimization 702 can have or include a set of optimized values 704 that respectively correspond (e.g., in one-to-one fashion) to the set of adjustable parameters 604. Since the set of adjustable parameters 604 can have k parameters, the set of optimized values 704 can have k values: an optimized value 704(1) to an optimized value 704(k). In various aspects, each of the set of optimized values 704 can be considered as a finalized or fully-updated value of a respective one of the set of adjustable parameters 604 that has been obtained via stochastic gradient descent. As a non-limiting example, the optimized value 704(1) can be considered as the finalized or fully-updated value which stochastic gradient descent has yielded for the adjustable parameter 604(1) (e.g., can be considered as whatever specific value which, when assigned to the adjustable parameter 604(1), causes the fidelity of the quantum circuit template 602 to satisfy the threshold fidelity value). As another non-limiting example, the optimized value 704(k) can be considered as the finalized or fully-updated value which stochastic gradient descent has yielded for the adjustable parameter 604(k) (e.g., can be considered as whatever specific value which, when assigned to the adjustable parameter 604(k), causes the fidelity of the quantum circuit template 602 to satisfy the threshold fidelity value).

In some aspects, it can be possible that the measured fidelity is not able to satisfy the threshold fidelity value. As a non-limiting example, it can be possible that the measured fidelity does not exceed the threshold fidelity value, even after the synthesis component 120 has performed any suitable threshold number of fidelity-measurement-and-parameter-update iterations. In such case, the synthesis component 120 can conclude that the quantum circuit template 602 is not capable of successfully synthesizing or transpiling the unitary matrix 112. Accordingly, the synthesis component 120 can repeat the actions described with respect to FIGS. 6-7 for whichever of the plurality of quantum circuit templates 108 is ranked by the template classification label 402 as next-highest after the quantum circuit template 602. In other words, the synthesis component 120 can consider, analyze, or attempt the plurality of quantum circuit templates 108 in order of decreasing suitability rank as indicated by the template classification label 402.

In any case, the synthesis component 120 can, at some point (unless none of the plurality of quantum circuit templates 108 ends up being suitable for synthesis or transpilation of the unitary matrix 112), generate the parameter optimization 702.

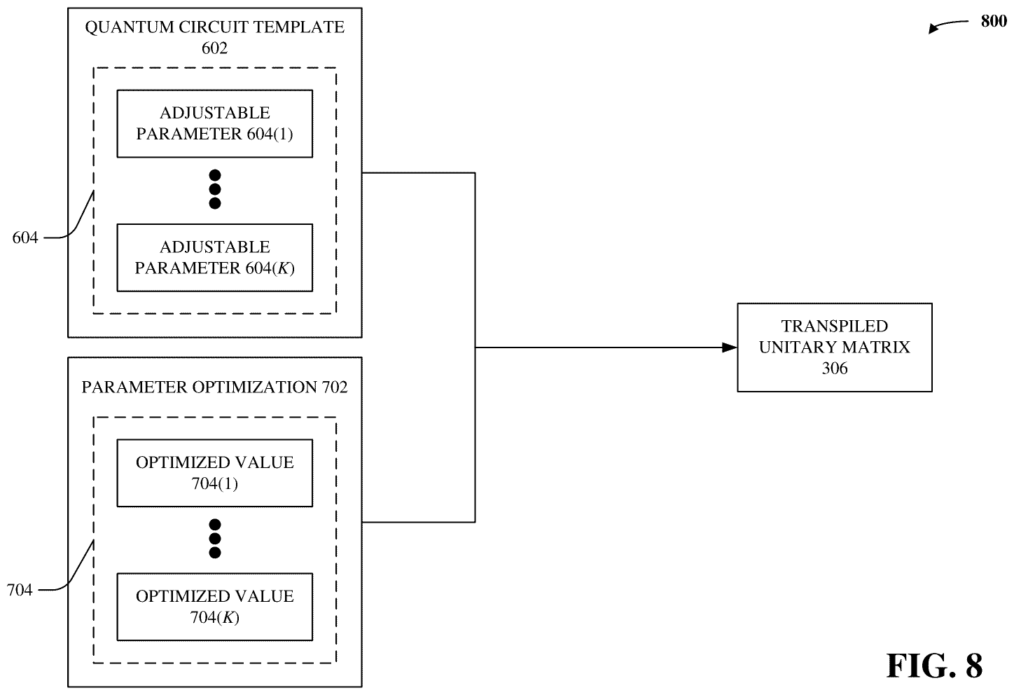

Now, consider FIG. 8. In various embodiments, the synthesis component 120 can generate the transpiled unitary matrix 306, based on the parameter optimization 702 and based on whichever one of the plurality of quantum circuit templates 108 yielded the parameter optimization 702. For ease of explanation and illustration, FIG. 8 treats the parameter optimization 702 as being yielded by the quantum circuit template 602 (e.g., as having been obtained during the application of stochastic gradient descent to the quantum circuit template 602). In various aspects, the synthesis component 120 can generate the transpiled unitary matrix 306 by respectively assigning the set of optimized values 704 to the set of adjustable parameters 604 (e.g., by plugging the optimized value 704(1) into the adjustable parameter 604(1), by plugging the optimized value 704(k) into the adjustable parameter 604(k)). In other words, the transpiled unitary matrix 306 can be considered as the quantum circuit template 602 when the adjustable parameters of the quantum circuit template 602 are filled with the parameter optimization 702.

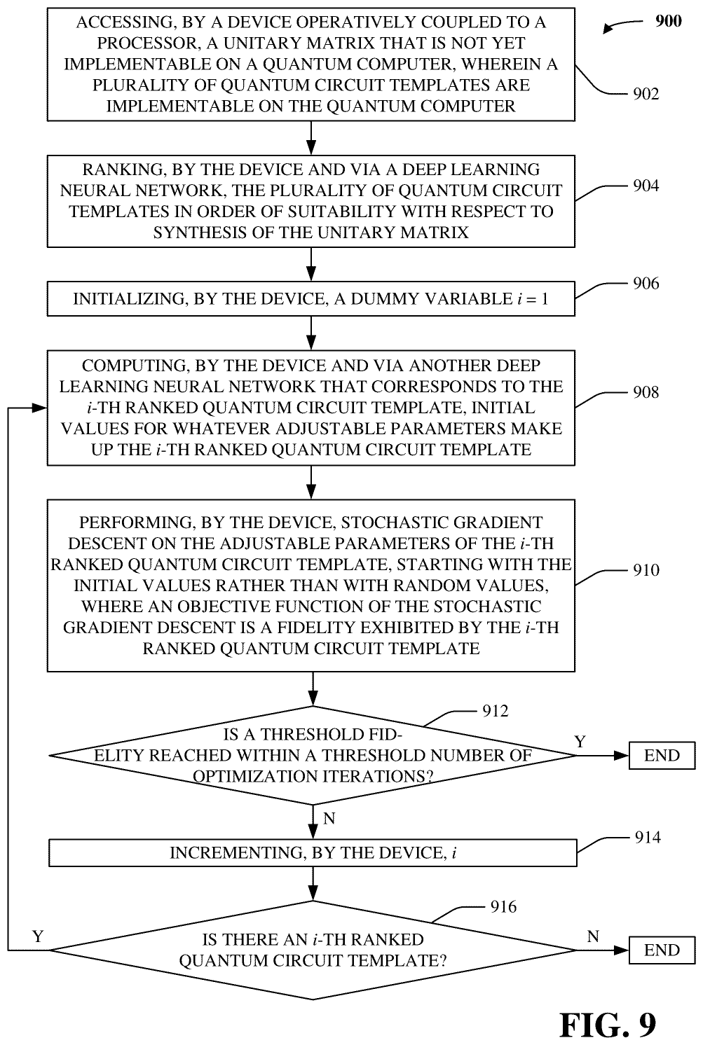

FIG. 9 illustrates a flow diagram of an example, non-limiting computer-implemented method 900 that can facilitate intelligent unitary synthesis for quantum computing in accordance with one or more embodiments described herein. In various cases, the transpilation system 102 can facilitate the computer-implemented method 900.

In various embodiments, act 902 can include accessing, by a device (e.g., via 118) operatively coupled to a processor (e.g., 114), a unitary matrix (e.g., 112) that is not yet implementable on a quantum computer (e.g., 104). In various cases, a plurality of quantum circuit templates (e.g., 108) can be implementable on the quantum computer.

In various aspects, act 904 can include ranking, by the device (e.g., via 120) and via a deep learning neural network (e.g., 302), the plurality of quantum circuit templates in order of suitability with respect to synthesis or transpilation of the unitary matrix.

In various instances, act 906 can include initializing, by the device (e.g., via 120), a dummy variable i=1.

In various cases, act 908 can include computing, by the device (e.g., via 120) and via another deep learning neural network (e.g., one of 304) that corresponds to the i-th ranked quantum circuit template, initial values (e.g., 606) for whatever adjustable parameters (e.g., 604) make up the i-th ranked quantum circuit template.

In various aspects, act 910 can include performing, by the device (e.g., via 120), stochastic gradient descent on the adjustable parameters of the i-th ranked quantum circuit template, starting with the initial values rather than with random values. In various cases, an objective function of the stochastic gradient descent can be based on a fidelity exhibited by the i-th ranked quantum circuit template with respect to the unitary matrix.

In various instances, act 912 can include determining, by the device (e.g., via 120 ), whether a threshold fidelity has been reached within a threshold number of optimization iterations. If so, the computer-implemented method 900 can end, with the finalized or most-recently-updated values of the adjustable parameters of the i-th ranked quantum circuit template being considered as a synthesized or transpiled version of the unitary matrix that is implementable on the quantum computer. If not, the computer-implemented method 900 can instead proceed to act 914.

In various cases, act 914 can include incrementing, by the device (e.g., via 120), i (e.g., such that i:=i+1).

In various aspects, act 916 can include determining, by the device (e.g., via 120), whether there is an i-th ranked quantum circuit template. If so, the computer-implemented method 900 can proceed back to act 908. If not, the computer-implemented method 900 can end, at which point none of the plurality of quantum circuit templates can be considered as suitable for synthesizing or transpiling the unitary matrix.

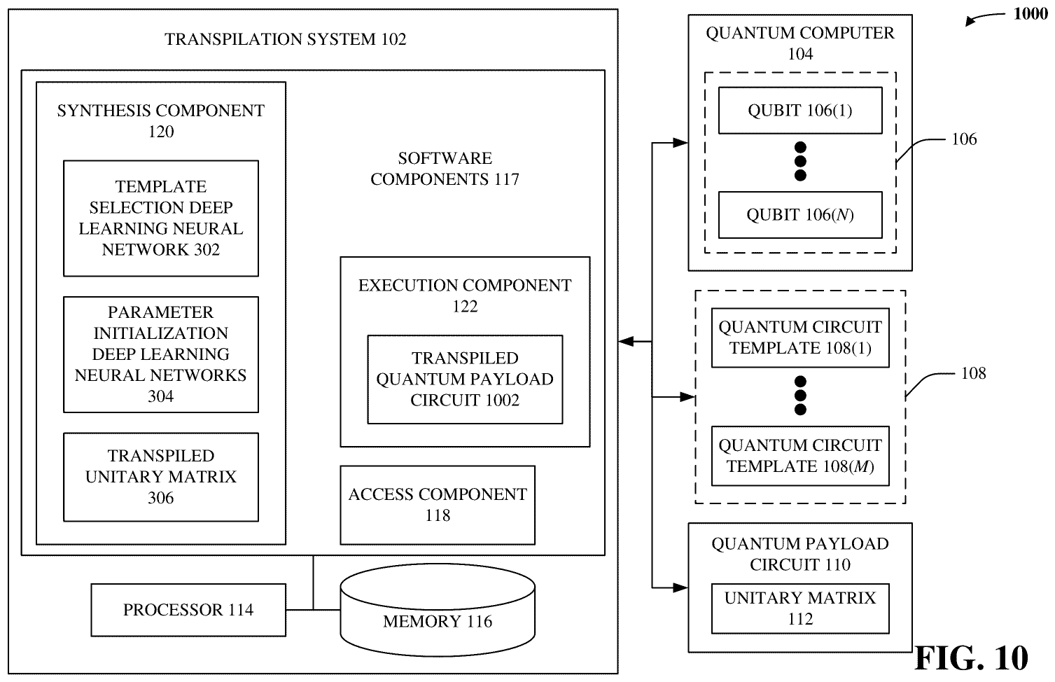

FIG. 10 illustrates a block diagram of an example, non-limiting system 1000 including a transpiled quantum payload circuit that can facilitate intelligent unitary synthesis for quantum computing in accordance with one or more embodiments described herein. As shown, the system 1000 can, in some cases, comprise the same components as the system 300, and can further comprise a transpiled quantum payload circuit 1002.

In various embodiments, the execution component 122 can replace the unitary matrix 112 inside of the quantum payload circuit 110 with the transpiled unitary matrix 306. After such replacement, the quantum payload circuit 110 can now be considered or referred to as the transpiled quantum payload circuit 1002. In various aspects, the execution component 122 can instruct, command, or otherwise cause the transpiled quantum payload circuit 1002 to be executed on, implemented on, or otherwise performed on the quantum computer 104. That is, the execution component 122 can initialize the states of the set of qubits 106 in any suitable fashion and can manipulate those initialized states according to whatever quantum operations are specified or otherwise called for by the transpiled quantum payload circuit 1002. After such execution, the execution component 122 can instruct, command, or otherwise cause the quantum computer 104 to perform a respective quantum read or measurement operation on each of the set of qubits 106.

Note that, if none of the plurality of quantum circuit templates 108 ends up being suitable for synthesis or transpilation of the unitary matrix 112 (e.g., if the probability score 406 is greater than each of the plurality of probability scores 404; or if “NO” is ever reached by act 916), the execution component 122 can electronically transmit or render to any suitable computing device or on any suitable electronic display a notification or message indicating such absence of suitability.

It should be understood or otherwise appreciated that the quantum payload circuit 110 can include any suitable number of unitary matrices that are not implementable on the quantum computer 104. In such situations, the transpilation system 102 can synthesize or transpile any or all of those unitary matrices as described herein to create the transpiled quantum payload circuit 1002.

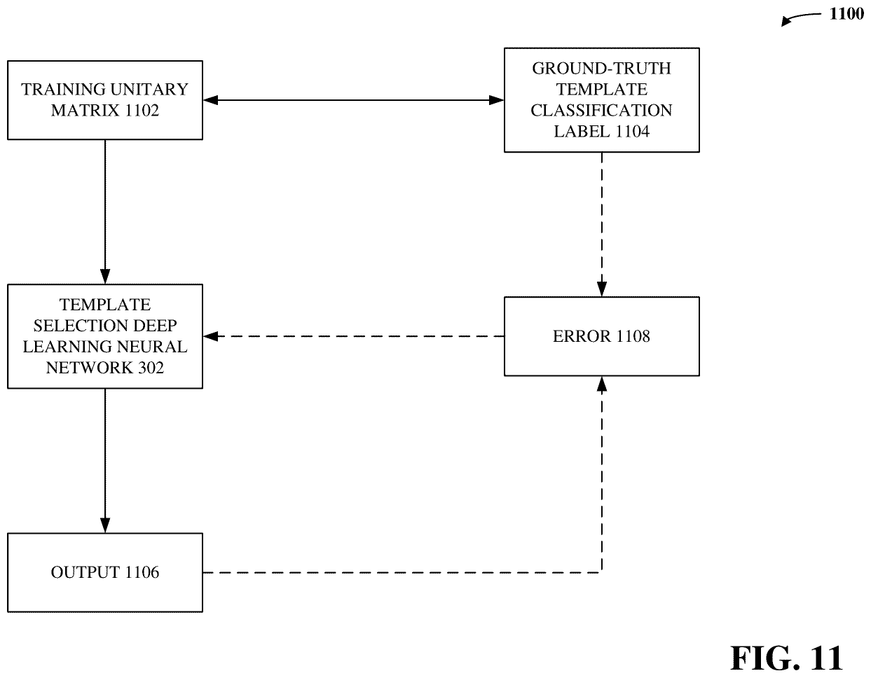

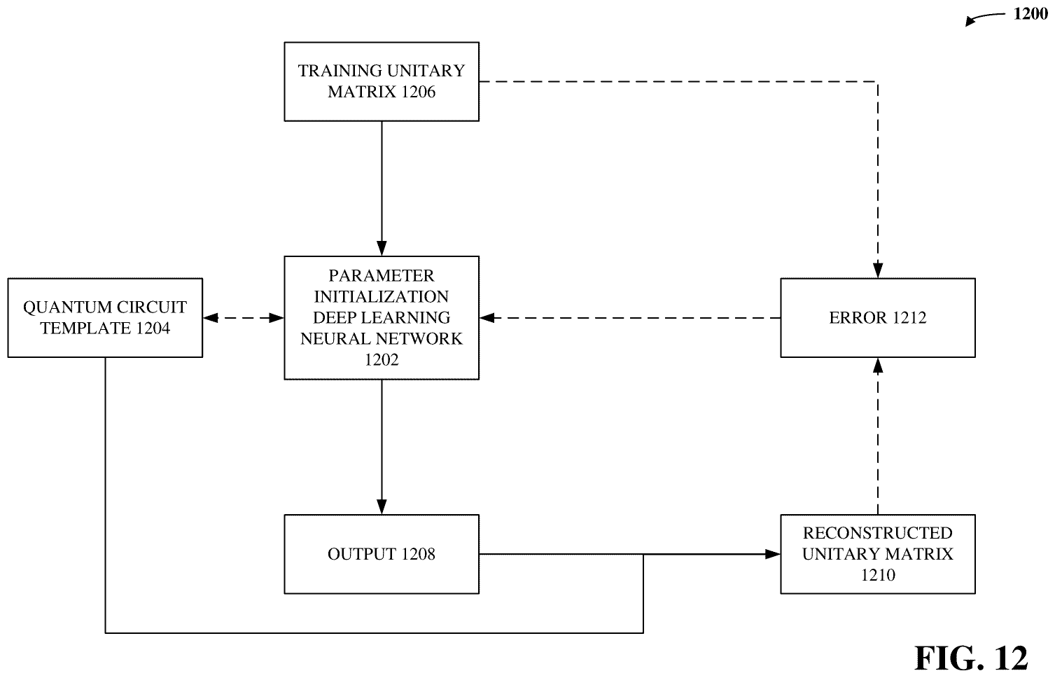

In order for the herein-described functionalities to be accurate, correct, or reliable, the various deep learning neural networks described herein can first undergo training. Non-limiting examples of such training are described with respect to FIGS. 11-12.

First, consider FIG. 11. FIG. 11 illustrates an example, non-limiting block diagram 1100 showing how the template selection deep learning neural network 302 can be trained in accordance with one or more embodiments described herein.

In various aspects, prior to beginning training, the trainable internal parameters (e.g., convolutional kernels, weight matrices, bias values) of the template selection deep learning neural network 302 can be initialized in any suitable fashion (e.g., via random initialization).

In various embodiments, there can be a training unitary matrix 1102 and a ground-truth template classification label 1104. In various aspects, the training unitary matrix 1102 can be any suitable unitary matrix (e.g., configured to operate on the same number of qubits as the unitary matrix 112), and the ground-truth template classification label 1104 can be whatever correct or accurate template classification label (e.g., having the same format, size, or dimensionality as the template classification label 402) is known or deemed to correspond to the training unitary matrix 1102. In various instances, the template selection deep learning neural network 302 can be executed on the training unitary matrix 1102, thereby causing the template selection deep learning neural network 302 to produce an output 1106. More specifically, in some cases, the training unitary matrix 1102 can be fed or routed to the input layer of the template selection deep learning neural network 302, the training unitary matrix 1102 can complete a forward pass through the one or more hidden layers of the template selection deep learning neural network 302, and the output layer of the template selection deep learning neural network 302 can compute the output 1106 based on activation maps or feature maps provided by the one or more hidden layers of the template selection deep learning neural network 302.

Note that the format, size, or dimensionality of the output 1106 can be dictated by the number, arrangement, sizes, or other characteristics of the neurons, convolutional kernels, LSTM layers, or other internal parameters of the output layer (or of any other layers) of the template selection deep learning neural network 302. Accordingly, the output 1106 can be forced to have any desired format, size, or dimensionality, by adding, removing, or otherwise adjusting characteristics of the output layer (or of any other layers) of the template selection deep learning neural network 302.

In various aspects, the output 1106 can be considered as the predicted or inferred template classification label that the template selection deep learning neural network 302 believes should correspond to the training unitary matrix 1102 (e.g., can include a respective predicted or inferred probability score for each of the plurality of quantum circuit templates 108). Note that, if the template selection deep learning neural network 302 has so far undergone no or little training, then the output 1106 can be highly inaccurate. In other words, the output 1106 can be very different from the ground-truth template classification label 1104.

In various aspects, an error 1108 (e.g., mean absolute error, mean squared error, cross-entropy error) between the output 1106 and the ground-truth template classification label 1104 can be computed. In various instances, the trainable internal parameters of the template selection deep learning neural network 302 can be incrementally updated via backpropagation (e.g., stochastic gradient descent) based on the error 1108.

In various cases, such execution-and-update procedure can be repeated for any suitable number of training unitary matrices. This can ultimately cause the trainable internal parameters of the template selection deep learning neural network 302 to become iteratively optimized for accurately producing synthesis or transpilation probability scores for the plurality of quantum circuit templates 108 based on inputted unitary operators. In various aspects, any suitable training batch sizes, any suitable error/loss functions, or any suitable training termination criteria can be utilized during such training.

Although FIG. 11 shows the template selection deep learning neural network 302 as being trained in supervised fashion, this is a mere non-limiting example for ease of explanation and illustration. In various embodiments, any other suitable training paradigms can be used to train the template selection deep learning neural network 302, such as unsupervised training or reinforcement learning, any of which may be federated or non-federated.

Next, consider FIG. 12. FIG. 12 illustrates an example, non-limiting block diagram 1200 showing how any of the plurality of parameter initialization deep learning neural networks 304 can be trained in accordance with one or more embodiments described herein. A parameter initialization deep learning neural network 1202 can be any of the plurality of parameter initialization deep learning neural networks 304, and whichever of the plurality of quantum circuit templates 108 that the parameter initialization deep learning neural network 1202 corresponds to can be referred to as a quantum circuit template 1204.

In various aspects, prior to beginning training, the trainable internal parameters (e.g., convolutional kernels, weight matrices, bias values) of the parameter initialization deep learning neural network 1202 can be initialized in any suitable fashion (e.g., via random initialization).

In various embodiments, there can be a training unitary matrix 1206. In various aspects, the training unitary matrix 1206 can be any suitable unitary matrix (e.g., configured to operate on the same number of qubits as the unitary matrix 112). In various instances, the parameter initialization deep learning neural network 1202 can be executed on the training unitary matrix 1206, thereby causing the parameter initialization deep learning neural network 1202 to produce an output 1208. More specifically, in some cases, the training unitary matrix 1206 can be fed or routed to the input layer of the parameter initialization deep learning neural network 1202, the training unitary matrix 1206 can complete a forward pass through the one or more hidden layers of the parameter initialization deep learning neural network 1202, and the output layer of the parameter initialization deep learning neural network 1202 can compute the output 1208 based on activation maps or feature maps provided by the one or more hidden layers of the parameter initialization deep learning neural network 1202.

Note that the format, size, or dimensionality of the output 1208 can be dictated by the number, arrangement, sizes, or other characteristics of the neurons, convolutional kernels, LSTM layers, or other internal parameters of the output layer (or of any other layers) of the parameter initialization deep learning neural network 1202. Accordingly, the output 1208 can be forced to have any desired format, size, or dimensionality, by adding, removing, or otherwise adjusting characteristics of the output layer (or of any other layers) of the parameter initialization deep learning neural network 1202.

In various aspects, the output 1208 can be considered as the predicted or inferred parameter initialization that the parameter initialization deep learning neural network 1202 believes should correspond to the training unitary matrix 1206. That is, the output 1208 can include a respective predicted or inferred initialized value for each of the adjustable parameters of the quantum circuit template 1204, where the parameter initialization deep learning neural network 1202 believes that plugging such initialized values into the quantum circuit template 1204 will maximize a fidelity of the quantum circuit template 1204 with respect to the training unitary matrix 1206. Note that, if the parameter initialization deep learning neural network 1202 has so far undergone no or little training, then the output 1208 can be highly inaccurate (e.g., the output 1208 can fail to maximize the fidelity of the quantum circuit template 1204 with respect to the training unitary matrix 1206).

In various aspects, the initialized values represented by the output 1208 can be plugged into or otherwise assigned to the adjustable parameters of the quantum circuit template 1204. After such plugging or assignment, the quantum circuit template 1204 can be referred to as a reconstructed unitary matrix 1210. In various aspects, an error 1212 (e.g., mean absolute error, mean squared, cross-entropy error) between the reconstructed unitary matrix 1210 and the training unitary matrix 1206 can be computed. In some cases, the error 1212 can be equal to a complement of a fidelity that the reconstructed unitary matrix 1210 exhibits with respect to the training unitary matrix 1206 (e.g., such fidelity can be measured in any suitable fashion, such as via quantum state tomography). In various instances, the trainable internal parameters of the parameter initialization deep learning neural network 1202 can be incrementally updated via backpropagation (e.g., stochastic gradient descent) based on the error 1212.

In various cases, such execution-and-update procedure can be repeated for any suitable number of training unitary matrices. This can ultimately cause the trainable internal parameters of the parameter initialization deep learning neural network 1202 to become iteratively optimized for accurately producing parameter initializations for the quantum circuit template 1204 based on inputted unitary operators. In various aspects, any suitable training batch sizes, any suitable error/loss functions, or any suitable training termination criteria can be utilized during such training.

Although FIG. 12 shows the parameter initialization deep learning neural network 1202 as being trained in unsupervised fashion, this is a mere non-limiting example for ease of explanation and illustration. In various embodiments, any other suitable training paradigms can be used to train the parameter initialization deep learning neural network 1202, such as supervised training or reinforcement learning, any of which may be federated or non-federated.

FIGS. 13-16 illustrate example, non-limiting experimental results in accordance with one or more embodiments described herein.

FIG. 13 shows a table 1300 that depicts results of various experiments conducted by the present inventors. Such experiments involved various embodiments of the template selection deep learning neural network 302 having various network sizes and which were respectively trained to rank various 2-qubit circuit templates (e.g., n=2), various different 3-qubit circuit templates (e.g., n=3) each containing up to three CZ gates, and various different 3-qubit circuit templates (e.g., n=3) each containing up to 5 CZ gates. For the 2-qubit experiments, the template selection deep learning neural network 302 was trained to rank a total of four different templates (e.g., m=4): one template having no CZ gates; one template having one CZ gate; one template having two CZ gates; and one template having three CZ gates. For the 3-qubit experiments up to three CZ gates, the template selection deep learning neural network 302 was trained to rank a total of 15 different templates (e.g., m=15). For the 3-qubit experiments up to five CZ gates, the template selection deep learning neural network 302 was trained to rank a total of 63 different templates (e.g., m=63). As shown, validation accuracy of about 96% was achieved for the 2-qubit situations. That is, the highest ranked template identified by the template selection deep learning neural network 302 in the 2-qubit situations was the correct, accurate, or ground-truth template about 96% of the time. As also shown, validation accuracy of about 75% was achieved for the 3-qubit situations up to three CZ gates. That is, the highest ranked template identified by the template selection deep learning neural network 302 in the 3-qubit situations up to three CZ gates was the correct, accurate, or ground-truth template about 75% of the time. Although not explicitly shown in the table 1300, the top two templates identified by the template selection deep learning neural network 302 in such 3-qubit situations included the correct, accurate, or ground-truth template about 98% of the time. Lastly, as shown, validation accuracy of about 37% was achieved for the 3-qubit situations up to five CZ gates. That is, the highest ranked template identified by the template selection deep learning neural network 302 in the 3-qubit situations up to five CZ gates was the correct, accurate, or ground-truth template about 37% of the time. Although not explicitly shown in the table 1300, the top five templates identified by the template selection deep learning neural network 302 in such 3-qubit situations included the correct, accurate, or ground-truth template about 75% of the time. These results imply that, in such 3-qubit situations, the correct, accurate, or ground-truth template will be identified with an average of only 3.5 template attempts (e.g., 3.5 failed performances of stochastic gradient descent until a suitable template is found). Contrast this with the random guessing of existing techniques, which would instead require an average of 31.5 template attempts before identifying the correct, accurate, or ground-truth template.

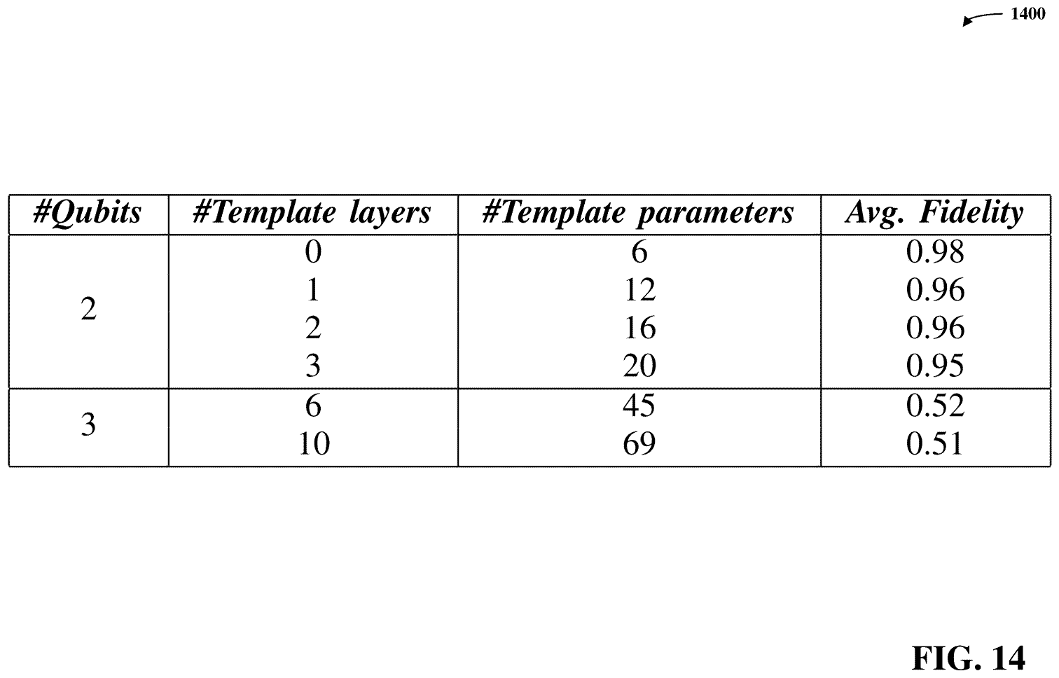

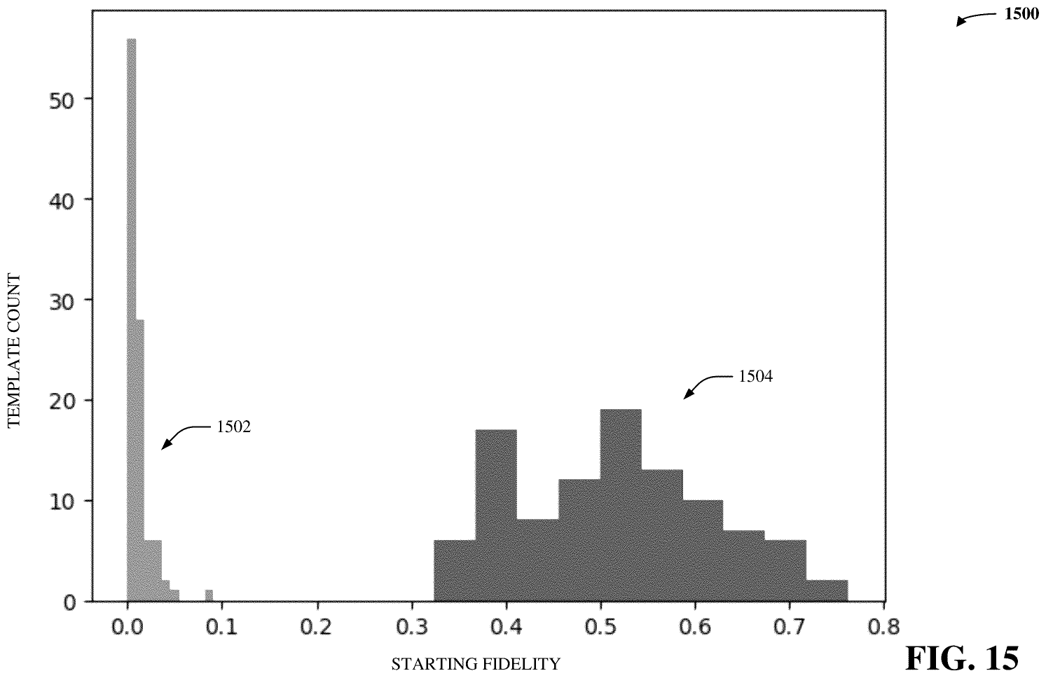

FIG. 14 shows a table 1400 that depicts results of various experiments conducted by the present inventors. Such experiments involved various embodiments of a parameter initialization deep learning neural network (e.g., any of 304) being respectively trained to predict initial parameter values for 2-qubit circuit templates (e.g., n=2) having 0, 1, 2, or 3 CZ gates and respective numbers of adjustable parameters (e.g., respective values of k), as well as for 3-qubit circuit templates (e.g., n=3) having 6 or 10 CZ gates and respective numbers of adjustable parameters. The table 1400 includes the starting or initial fidelities achieved when plugging the parameter initializations predicted by the parameter initialization deep learning neural network into the respective templates (prior to performance of stochastic gradient descent on those respective templates). As shown, average starting or initial fidelities of about 96% were achieved in the 2-qubit cases, meaning that the 2-qubit predicted parameter initializations astronomically outperformed random parameter initializations. As also shown, average starting or initial fidelities above 50% were achieved in the 3-qubit cases, which is still significantly better than starting or initial fidelities achieved by random parameter initializations. Indeed, this is shown in FIG. 15.

FIG. 15 depicts a graph 1500 whose horizontal axis represents starting or initial fidelity and whose vertical axis represents template count (e.g., how many distinct templates had respective starting or initial fidelities). Numeral 1502 shows a distribution of 3-qubit templates whose adjustable parameters were randomly initialized. As can be seen, prior to performing stochastic gradient descent, those randomly initialized 3-qubit templates exhibited extremely low starting or initial fidelities (e.g., around 0.01 or 0.02). Numeral 1504 , on the other hand, shows a distribution of those same 3-qubit templates whose adjustable parameters were initialized via the parameter initialization deep learning neural network mentioned above. As can be seen, prior to performing stochastic gradient descent, those non-randomly initialized 3-qubit templates exhibited significantly higher starting or initial fidelities (e.g., ranging from 0.35 to 0.75, with an average of about 0.51).

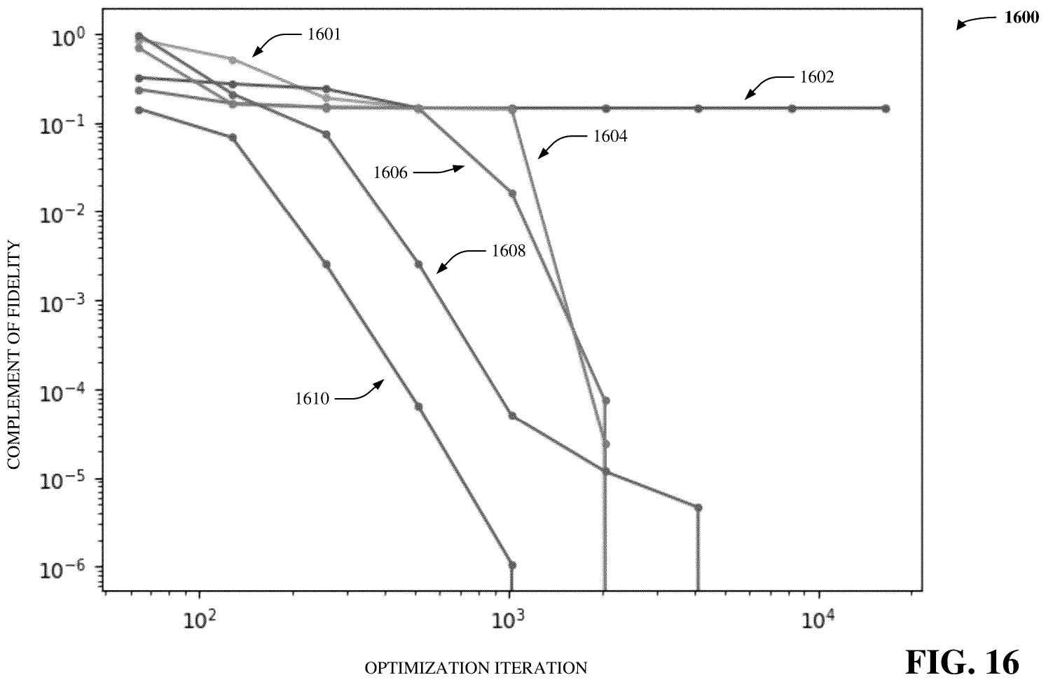

Lastly, FIG. 16 depicts a graph 1600 whose horizontal axis represents indices of stochastic gradient descent iterations and whose vertical axis represents the complement of template fidelity with respect to a given unitary matrix. For one particular circuit template (e.g., 602), numerals 1601, 1602, 1604, 1606, and 1608 represent respective performances of stochastic gradient descent on that particular circuit template starting or beginning from distinct five random initializations of the adjustable parameters of that particular circuit template. In contrast, numeral 1610 represents a performance of stochastic gradient descent on that particular circuit template starting or beginning from a parameter initialization predicted by the above-mentioned parameter initialization deep learning neural network. As shown, numeral 1610 converged to maximum fidelity faster than any of numerals 1601-1608 (e.g., many thousands of iterations faster, which qualifies as more than two to four multiples faster). As also shown, numeral 1601 and 1602 never converged at all. Instead, they got trapped at local minima, notwithstanding that the particular circuit template was capable of converging to the threshold or maximized fidelity.

These experimental results help to demonstrate that various embodiments described herein constitute concrete and tangible technical improvements in the field of quantum circuit transpilation.

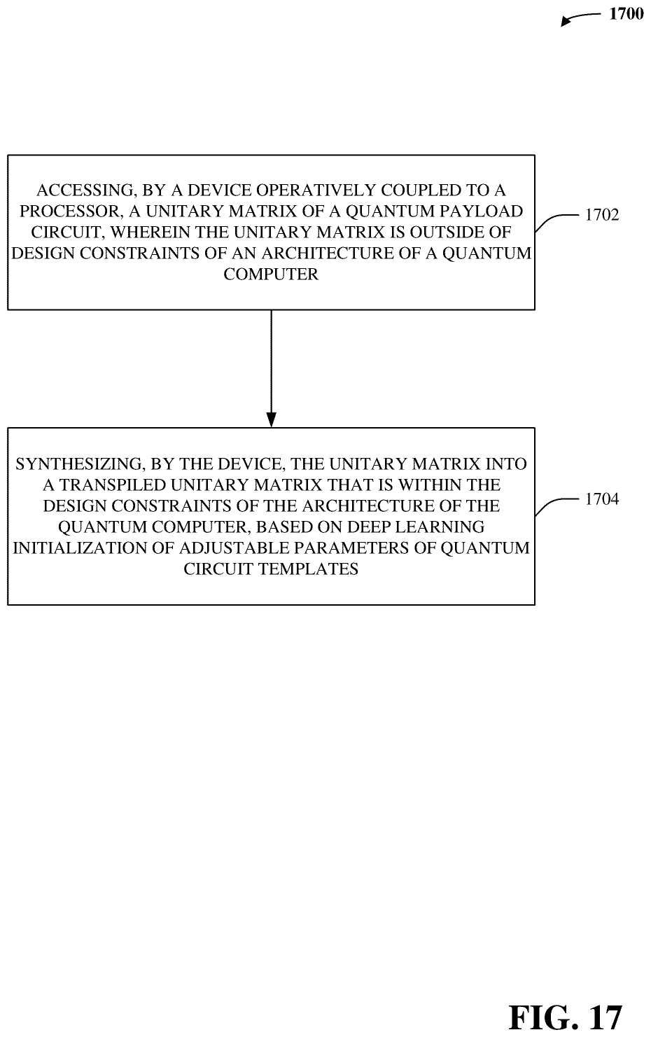

FIG. 17 illustrates a flow diagram of an example, non-limiting computer-implemented method 1700 that can facilitate intelligent unitary synthesis for quantum computing in accordance with one or more embodiments described herein. In various cases, the transpilation system 102 can facilitate the computer-implemented method 1700.

In various embodiments, act 1702 can include accessing, by a device (e.g., via 118) operatively coupled to a processor (e.g., 114), a unitary matrix (e.g., 112) of a quantum payload circuit (e.g., 110), wherein the unitary matrix is outside of design constraints of an architecture of a quantum computer.

In various aspects, act 1704 can include synthesizing, by the device (e.g., via 120), the unitary matrix into a transpiled unitary matrix (e.g., 306) that is within the design constraints of the architecture of the quantum computer, based on deep learning initialization of adjustable parameters of quantum circuit templates.

Although not explicitly shown in FIG. 17, the computer-implemented method 1700 can include replacing, by the device (e.g., via 122), the unitary matrix in the quantum payload circuit with the transpiled unitary matrix, thereby yielding a transpiled quantum payload circuit (e.g., 1002); and executing, by the device (e.g., via 122), the transpiled quantum payload circuit on the quantum computer.

Although not explicitly shown in FIG. 17, a plurality of quantum circuit templates (e.g., 108) can be within the design constraints of the architecture of the quantum computer, and the synthesizing can comprise: ranking, by the device (e.g., via 120) and via execution of a first deep learning neural network (e.g., 302), the plurality of quantum circuit templates in order of suitability with respect to the unitary matrix; initializing, by the device (e.g., via 120) and via execution of a second deep learning neural network (e.g., 605) corresponding to a highest-ranking quantum circuit template (e.g., 602) from the plurality of quantum circuit templates, one or more first adjustable parameters (e.g., 604) of the highest-ranking quantum circuit template; and performing, by the device (e.g., via 120), gradient descent optimization on the one or more first adjustable parameters starting from one or more first initialized values (e.g., 608) produced by the second deep learning neural network until a threshold fidelity is achieved, thereby yielding the transpiled unitary matrix. In some cases, the computer-implemented method 1700 can include: in response to the threshold fidelity not being achieved after a threshold number of optimization iterations, initializing, by the device (e.g., via 120) and via execution of a third deep learning neural network (e.g., another of 304) corresponding to a next-highest-ranking quantum circuit template (e.g., indicated by 402) from the plurality of quantum circuit templates, one or more second adjustable parameters of the next-highest-ranking quantum circuit template; and performing, by the device, gradient descent optimization on the one or more second adjustable parameters starting from one or more second initialized values produced by the third deep learning neural network until the threshold fidelity is achieved, thereby yielding the transpiled format.

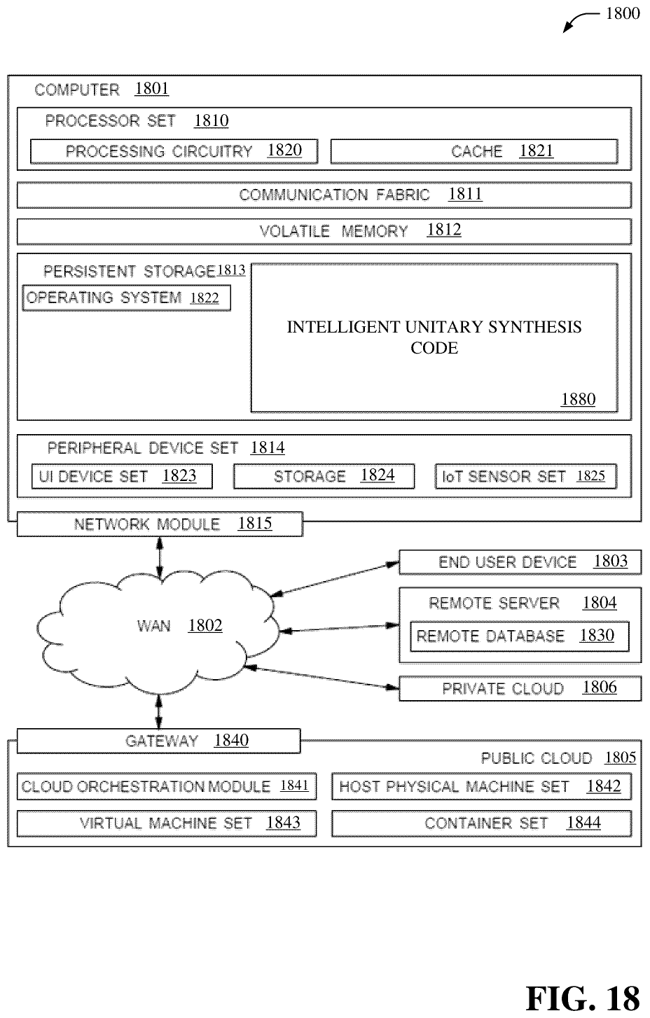

FIG. 18 and the following discussion are intended to provide a brief, general description of a suitable computing environment 1800 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1800 contains an example of an environment for the execution of at least some of the computer code involved in performing the inventive methods, such as intelligent unitary synthesis code 1880. In addition to block 1880, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1880, as identified above), peripheral device set 1814 (including user interface (UI), device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

COMPUTER 1801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method can be distributed among multiple computers or between multiple locations. On the other hand, in this presentation of computing environment 1800, detailed discussion is focused on a single computer, specifically computer 1801, to keep the presentation as simple as possible. Computer 1801 can be located in a cloud, even though it is not shown in a cloud in FIG. 18. On the other hand, computer 1801 is not required to be in a cloud except to any extent as can be affirmatively indicated.

PROCESSOR SET 1810 includes one, or more, computer processors of any type now known or to be developed in the future. Processing circuitry 1820 can be distributed over multiple packages, for example, multiple, coordinated integrated circuit chips. Processing circuitry 1820 can implement multiple processor threads or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set can be located “off chip.” In some computing environments, processor set 1810 can be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods can be stored in block 1880 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1812 is any type of volatile memory now known or to be developed in the future. Examples include dynamic type random access memory (RAM) or static type RAM. Typically, the volatile memory is characterized by random access, but this is not required unless affirmatively indicated. In computer 1801, the volatile memory 1812 is located in a single package and is internal to computer 1801, but, alternatively or additionally, the volatile memory can be distributed over multiple packages or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 or directly to persistent storage 1813. Persistent storage 1813 can be a read only memory (ROM), but typically at least a portion of the persistent storage allows writing of data, deletion of data and re-writing of data. Some familiar forms of persistent storage include magnetic disks and solid-state storage devices. Operating system 1822 can take several forms, such as various known proprietary operating systems or open-source Portable Operating System Interface type operating systems that employ a kernel. The code included in block 1880 typically includes at least some of the computer code involved in performing the inventive methods.

PERIPHERAL DEVICE SET 1814 includes the set of peripheral devices of computer 1801. Data communication connections between the peripheral devices and the other components of computer 1801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1823 can include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 can be persistent or volatile. In some embodiments, storage 1824 can take the form of a quantum computing storage device for storing data in the form of qubits. In embodiments where computer 1801 is required to have a large amount of storage (for example, where computer 1801 locally stores and manages a large database) then this storage can be provided by peripheral storage devices designed for storing large amounts of data, such as a storage area network (SAN) that is shared by multiple, geographically distributed computers. IoT sensor set 1825 is made up of sensors that can be used in Internet of Things applications. For example, one sensor can be a thermometer and another sensor can be a motion detector.

NETWORK MODULE 1815 is the collection of computer software, hardware, and firmware that allows computer 1801 to communicate with other computers through WAN 1802.

Network module 1815 can include hardware, such as modems or Wi-Fi signal transceivers, software for packetizing or de-packetizing data for communication network transmission, or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801) and can take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 can be a client device, such as thin client, heavy client, mainframe computer or desktop computer.

REMOTE SERVER 1804 is any computer system that serves at least some data or functionality to computer 1801. Remote server 1804 can be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data can be provided to computer 1801 from remote database 1830 of remote server 1804.

PUBLIC CLOUD 1805 is any computer system available for use by multiple entities that provides on-demand availability of computer system resources or other computer capabilities, especially data storage (cloud storage) and computing power, without direct active management by the scale. The direct and active management of the computing resources of public cloud 1805 is performed by the computer hardware or software of cloud orchestration module 1841. The computing resources provided by public cloud 1805 are typically implemented by virtual computing environments that run on various computers making up the computers of host physical machine set 1842, which is the universe of physical computers in or available to public cloud 1805. The virtual computing environments (VCEs) typically take the form of virtual machines from virtual machine set 1843 or containers from container set 1844. It is understood that these VCEs can be stored as images and can be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware and firmware allowing public cloud 1805 to communicate through WAN 1802.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1805 and private cloud 1806 are both part of a larger hybrid cloud.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all”of that particular object or component.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable instructions stored in a non-transitory computer-readable memory, where execution of the computer-executable instructions causes the processor to perform operations comprising:
accessing a unitary matrix of a quantum payload circuit, wherein the unitary matrix is outside of design constraints of an architecture of a quantum computer; and
synthesizing the unitary matrix into a transpiled unitary matrix that is within the design constraints of the architecture of the quantum computer, based on deep learning initialization of adjustable parameters of quantum circuit templates.

2. The system of claim 1, wherein the operations further comprise:
replacing the unitary matrix in the quantum payload circuit with the transpiled unitary matrix, thereby yielding a transpiled quantum payload circuit; and
executing the transpiled quantum payload circuit on the quantum computer.

3. The system of claim 2, wherein a plurality of quantum circuit templates are within the design constraints of the architecture of the quantum computer, and wherein the synthesizing comprises:
ranking, via execution of a first deep learning neural network, the plurality of quantum circuit templates in order of suitability with respect to the unitary matrix.

4. The system of claim 3, wherein the synthesizing comprises:
initializing, via execution of a second deep learning neural network that corresponds to a highest-ranking quantum circuit template from the plurality of quantum circuit templates, one or more first adjustable parameters of the highest-ranking quantum circuit template.

5. The system of claim 4, wherein the synthesizing comprises:
performing gradient descent optimization on the one or more first adjustable parameters starting from one or more first initialized values produced by the second deep learning neural network until a threshold fidelity is achieved, thereby yielding the transpiled unitary matrix.

6. The system of claim 5, wherein the synthesizing comprises:
in response to the threshold fidelity not being achieved after a threshold number of iterations, initializing, via execution of a third deep learning neural network corresponding to a next-highest-ranking quantum circuit template from the plurality of quantum circuit templates, one or more second adjustable parameters of the next-highest-ranking quantum circuit template; and
performing gradient descent optimization on the one or more second adjustable parameters starting from one or more second initialized values produced by the third deep learning neural network until the threshold fidelity is achieved, thereby yielding the transpiled unitary matrix.

7. The system of claim 5, wherein the one or more first adjustable parameters are qubit rotation angles.

8. The system of claim 3, wherein the first deep learning neural network is configured to produce as output:
a respective probability indicating how likely it is that each of the plurality of quantum circuit templates is suitable for the unitary matrix; and
another probability indicating how likely it is that none of the plurality of quantum circuit templates is suitable for the unitary matrix.

9. A computer-implemented method, comprising:
accessing, by a device operatively coupled to a processor, a unitary matrix of a quantum payload circuit, wherein the unitary matrix is outside of design constraints of an architecture of a quantum computer; and
synthesizing, by the device, the unitary matrix into a transpiled unitary matrix that is within the design constraints of the architecture of the quantum computer, based on deep learning initialization of adjustable parameters of quantum circuit templates.

10. The computer-implemented method of claim 9, further comprising:
replacing, by the device, the unitary matrix in the quantum payload circuit with the transpiled unitary matrix, thereby yielding a transpiled quantum payload circuit; and
executing, by the device, the transpiled quantum payload circuit on the quantum computer.

11. The computer-implemented method of claim 10, wherein a plurality of quantum circuit templates are within the design constraints of the architecture of the quantum computer, and wherein the synthesizing comprises:
ranking, by the device and via execution of a first deep learning neural network, the plurality of quantum circuit templates in order of suitability with respect to the unitary matrix.

12. The computer-implemented method of claim 11, wherein the synthesizing comprises:
initializing, by the device and via execution of a second deep learning neural network corresponding to a highest-ranking quantum circuit template from the plurality of quantum circuit templates, one or more first adjustable parameters of the highest-ranking quantum circuit template.

13. The computer-implemented method of claim 12, wherein the synthesizing comprises:
performing, by the device, gradient descent optimization on the one or more first adjustable parameters starting from one or more first initialized values produced by the second deep learning neural network until a threshold fidelity is achieved, thereby yielding the transpiled unitary matrix.

14. The computer-implemented method of claim 13, wherein the synthesizing comprises:
in response to the threshold fidelity not being achieved after a threshold number of iterations, initializing, by the device and via execution of a third deep learning neural network corresponding to a next-highest-ranking quantum circuit template from the plurality of quantum circuit templates, one or more second adjustable parameters of the next-highest-ranking quantum circuit template; and
performing, by the device, gradient descent optimization on the one or more second adjustable parameters starting from one or more second initialized values produced by the third deep learning neural network until the threshold fidelity is achieved, thereby yielding the transpiled unitary matrix.

15. The computer-implemented method of claim 13, wherein the one or more first adjustable parameters are qubit rotation angles.

16. The computer-implemented method of claim 11, wherein the first deep learning neural network is configured to produce as output:
a respective probability indicating how likely it is that each of the plurality of quantum circuit templates is suitable for the unitary matrix; and
another probability indicating how likely it is that none of the plurality of quantum circuit templates is suitable for the unitary matrix.

17. A computer program product for facilitating intelligent unitary synthesis for quantum computing, the computer program product comprising a non-transitory computer-readable memory having program instructions embodied therewith, the program instructions executable by a processor to cause the processor to:
access a unitary matrix of a quantum payload circuit, wherein the unitary matrix is outside of design constraints of an architecture of a quantum computer; and
synthesize the unitary matrix into a transpiled unitary matrix that is within the design constraints of the architecture of the quantum computer, based on deep learning initialization of adjustable parameters of quantum circuit templates.

18. The computer program product of claim 17, wherein the program instructions are executable to cause the processor to:
replace the unitary matrix in the quantum payload circuit with the transpiled unitary matrix, thereby yielding a transpiled quantum payload circuit; and
execute the transpiled quantum payload circuit on the quantum computer.

19. The computer program product of claim 18, wherein a plurality of quantum circuit templates are within the design constraints of the architecture of the quantum computer, and wherein the program instructions are executable to cause the processor to:
rank, via execution of a first deep learning neural network, the plurality of quantum circuit templates in order of suitability with respect to the unitary matrix.

20. The computer program product of claim 19, wherein the synthesizing comprises:
initializing, by the processor and via execution of a second deep learning neural network corresponding to a highest-ranking quantum circuit template from the plurality of quantum circuit templates, one or more first adjustable parameters of the highest-ranking quantum circuit template.
